(19) United States
(12) Patent Application Publication
(10) Pub. No.: US 2006/0212227 A1
(43) Pub. Date: Sep. 21, 2006

(54) An Analysis Platform for Annotating Comprehensive Functions of Genes on high throughput and Integrated Bioarray System

(76) Inventors: Xiaoliang Han, San Francisco, CA (US); Jinming Xia, San Francisco, CA (US)

Correspondence Address: Xiaoliang Han, 3507 Breakwater Ave, Hayward, CA, 94545, US

(21) Appl. No.: 10/907,025

(22) Filed: Mar. 16, 2005

(51) Int. Cl. G06F 19/00

(52) U.S. Cl. 702/19; 702/20

(57) ABSTRACT

This invention presents the analysis platform for annotating comprehensive functions of genes on high throughput and integrated bioarray system. High throughput and Integrated bioarray system produces the integrated information or data as functional patterns of DNA, RNA, protein, cDNA, tissue, and etc. from the same piece of biomaterials in a high throughput manner by vertical and comprehensive analysis. Horizontal and comprehensive analysis of the functional patterns of DNA, RNA, protein, cDNA, tissue, and etc., across different biomaterials under different conditions forms the three-dimensional database for the comprehensive functions of genes. The comprehensive functions of any gene or all related genes can be annotated from the three-dimensional database by computerized analysis. The analysis platform technologies with high throughput and integrated bioarray system are highly effective and powerful not only in getting vital information and data in the functions of genes but also in processing the obtained information and, furthermore, providing new strategies in diagnosis and treatments of diseases.

### BACKGROUND OF THE INVENTION 1. Field of the Invention

This invention presents the analysis platform for annotating comprehensive functions of genes on integrated bioarray system as outlined in FIG. 1. The comprehensive functions of genes refer the dynamic, complicated, interactive and integrated activities in genetic materials, such as DNA, RNA, proteins, and etc. across different biomaterials under different conditions. Vertical and horizontal analysis of the presentation status (resulting in expression profile, regulation in expression, and integrated effect) of DNA, RNA protein, and etc. across different biomaterials are the core processes to annotate the comprehensive functions of genes. The analysis platform consists of the integrated bioarray system, instruments and computer hardware or software for generating, collecting and processing information about the comprehensive function of genes in high throughput manners. The integrated bioarray system contains DNA array, RNA array, cDNA array, protein array, tissue array, or etc., which are produced from the same selection of different biomaterials respectively in a designated order. Specimens of DNA, RNA, protein, cDNA, tissue, and etc. from the same piece of biomaterial are corresponded to each other on integrated bioarray system. The functional patterns (expression profiles, regulations in expression, or integrated expression effect) of DNA, RNA, proteins, cDNA, tissues and etc. from biomaterials can be developed by the integrated bioarray system by vertical and comprehensive analysis of the presentation status. Horizontal and comprehensive analysis of the functional patterns of DNA, RNA, protein, cDNA, tissue, and etc., across different biomaterials under different conditions forms the three-dimensional database for the comprehensive functions of genes. The comprehensive functions of any gene or all related genes can be annotated from the three-dimensional database by computerized analysis.

Annotating the comprehensive functions of genes becomes the most urgent task in gene research because human genome project has discovered many novel genes that are expressed differently during development, tumor, inflammation, or other disease conditions. The daunting task of linking each gene expression at the messenger RNA level to its DNA, protein levels and to unravel the genes truly responsible for the causes or outcomes of certain diseases is still in the infancy. Traditionally, researchers approach one single gene mostly at one or two levels of gene regulation. Recently researchers can study many genes at once at one level, i.e. mRNA expression level with cDNA or oligonucleotides microarray technologies. However, these approaches at single gene or single level are not effective enough to reveal the functions of genes since the functions of genes involve many aspects of the dynamic, complicated, interactive and integrated activities in genetic materials, such as DNA, RNA, proteins, and etc.

We foresee the importance and necessities of determining the function of genes at all aspects of activities of genes, such as gene expression, gene regulation and biological effects of genes, for each biological sample to understand the comprehensive function of genes. Also, we believe the technology should be able to handle multiple samples at multiple levels of genetic materials simultaneously in order to determine the comprehensive function of genes. Therefore, we developed the analysis platform technologies with integrated bioarray system for this coming task facing the biomedical community.

Application of genetic materials on the integrated bioarray system will display the presentation status of DNA, RNA, protein, cDNA, tissue, and etc. in biomaterials. The presentation status of DNA, RNA, protein, cDNA, tissue, and etc. in biomaterials are the direct indicators of its activities, which are identified according to the standards and parameters with different natures by the analysis platform technologies with integrated bioarray system. The identified presentation status of DNA, RNA, protein, cDNA, tissue, and etc. forms the functional patterns of the genetic materials. The presentation status usually are not analyzed all together toward one gene at the same time in current research protocols because it is usually beyond the capabilities or under limitation in terms of products, instrumentations, timeline, and manpower in most research institutes. Plus difficulties to obtain and analyze across many pieces of biomaterials under different conditions, it is impossible to achieve without current invention or similar system. Thus, a vertical and comprehensive analysis of these different natures of parameters and standards is a key step now to understand how DNA, RNA, protein, cDNA from a single gene works together correspondingly.

The presentation status of DNA, RNA, protein, cDNA, tissue, and etc. from one gene can be varied in one piece of biomaterial under one condition from different biomaterials under different conditions. For instance, oncogenes are the “normal” genes existed in an “abnormal” presentation status of DNA, RNA, protein, cDNA, tissue, and etc. One vertical and comprehensive analysis as described above can only identify one particular functional patterns of DNA, RNA, protein, cDNA, tissue, and etc. of one gene in one piece of biomaterial under one condition. To identify the functional patterns of DNA, RNA, protein, cDNA, tissue, and etc. of one gene in different pieces of biomaterials under different conditions, a horizontal and comprehensive analysis of the functional patterns of DNA, RNA, protein, cDNA, tissue, and etc. from the gene must be performed across the different pieces of biomaterials under different conditions. Therefore, the comprehensive functions of genes are the integrated results of vertically and horizontally comprehensive analysis of the presentation status and the functional patterns of DNA, RNA, protein, cDNA, tissue, and etc. performed across the different pieces of biomaterials under different conditions. The integrated information or data of the functional patterns from different genes on different biomaterials under different conditions forms the three-dimensional database for the comprehensive functions of gene. The comprehensive functions of any gene or all genes can be annotated from the three-dimensional database by horizontal, comprehensive, and computerized analysis.

### SUMMARY OF THE INVENTION

This invention presents the analysis platform for annotating comprehensive functions of genes on high throughput and integrated bioarray system. High throughput and Integrated bioarray system produces the integrated information or data as functional patterns of DNA, RNA, protein, cDNA, tissue, and etc. from the same piece of biomaterials in a high throughput manner by vertical and comprehensive analysis. Horizontal and comprehensive analysis of the functional patterns of DNA, RNA, protein, cDNA, tissue, and etc., across different biomaterials under different conditions forms the three-dimensional database for the comprehensive functions of genes. The comprehensive functions of any gene or all related genes can be annotated from the three-dimensional database by computerized analysis. The analysis platform technologies with high throughput and integrated bioarray system are highly effective and powerful not only in getting vital information and data in the functions of genes but also in processing the obtained information and, furthermore, providing new strategies in diagnosis and treatments of diseases.

### BRIEF DESCRIPTION OF DRAWINGS AND FIGURES

FIG. 1. Analysis Platform for Comprehensive Function of Genes

Right column of flow chart of the analysis platform for comprehensive function of genes shows the process flow and left column explains the process flow. The key steps are: collect DNA, RNA and protein from the same piece of biomaterials; display presentation status of DNA, RNA and protein; vertical analysis of presentation status; develop functional patterns and annotate conditioned functions of genes; horizontal analysis across many tissues; build up three dimensional database for functions of genes; and annotate comprehensive functions of genes.

FIG. 2. The Central Dogma of Molecular biology

The Central Dogma of Molecular biology shows the vertical relationship of genetic materials (DNA, RNA and protein). DNA is duplicated itself at DNA replication level; RNA is synthesized according to DNA at transcription level, and protein is synthesized according to RNA at translation level. Genetic information is flowed from DNA to protein, which is defined here as vertical process.

FIG. 3. Parameters and Standards in Integrated Bioarray System

Amounts, sizes, fidelities and locations are four parameters that measure the information of genetic materials presented by Integrated Bioarray System. The variation, polymorphisms, mutation are three standards used to judge parameters. The mutation is the changes that cause abnormal status of organisms while polymorphisms are the changes that do not cause abnormal status of organisms. The variations include mutation, polymorphisms, normal status, and some unknown consequences.

FIG. 4. Diagram of specimens from genetic materials on Integrated Bioarray System

Panel A shows the arrangement of DNA or RNA specimens on DNA or RNA array products. Panel B shows the arrangement of protein specimens on protein array products. There are six tissues and each tissue gives three subcellular compartments as cytosol (C); nucleus (N); and membrane (M). Membrane positions are blank for DNA or RNA array products since there are no DNA or RNA in this subcellular compartment. 20 fractions (Ft) of fractionated DNA, RNA or protein are arrayed sequentially on array products respectively.

FIG. 5. Expression of EGFR protein detected on Integrated Bioarray System

Panel A shows the actually size of protein array product in the Integrated Bioarray System. DNA array product and RNA array product have the similar sizes. Panel B is the enlarged size of protein array in Panel A. Protein specimens on protein array product are isolated from subcellular compartments of six different tissues and fractionated. Anti-EGFR antibody is applied on this protein array product to detect expression of EGFR protein. EGFR proteins are expressed very differently among human normal adult tissue, human fetal tissue and human tumor tissues in different subcellular compartments with three different molecular weights.

FIG. 6. Expression of EGFR RNA detected on Integrated Bioarray System

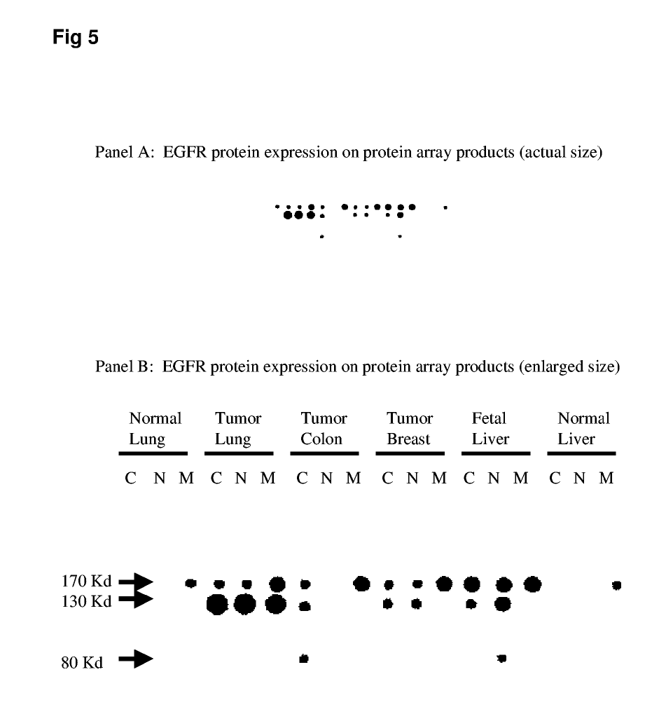

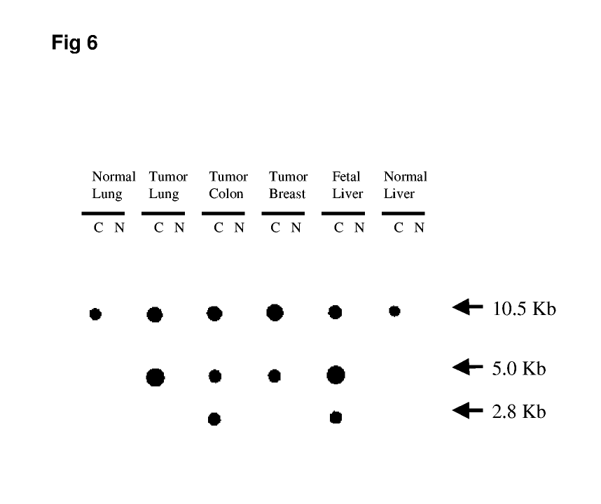

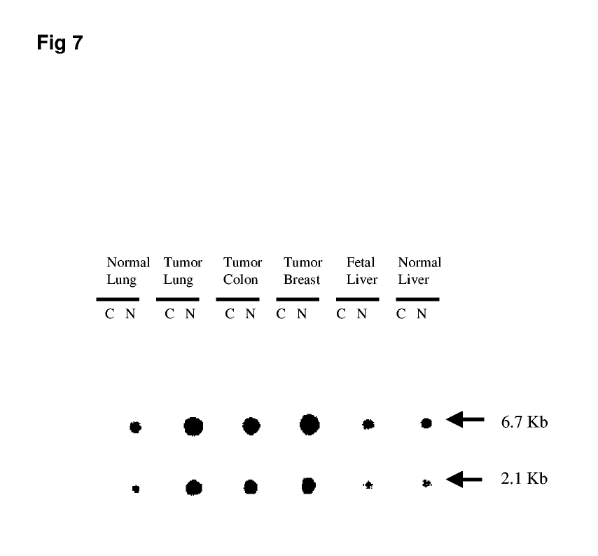

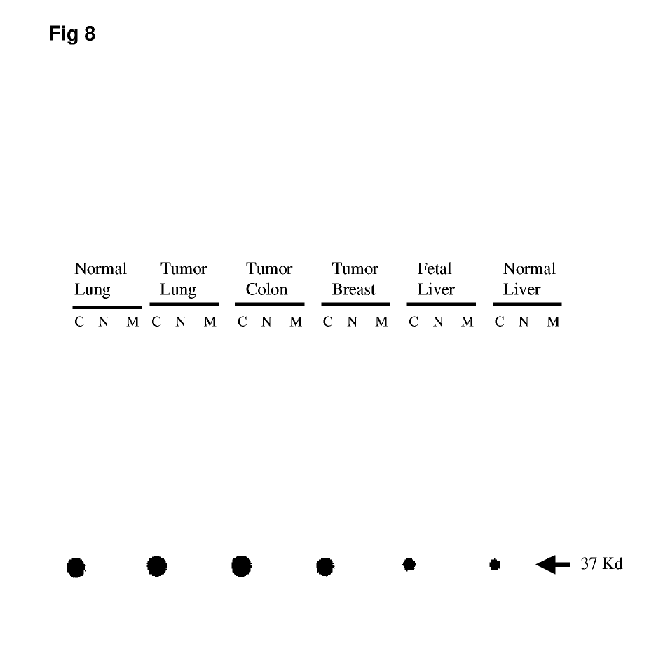

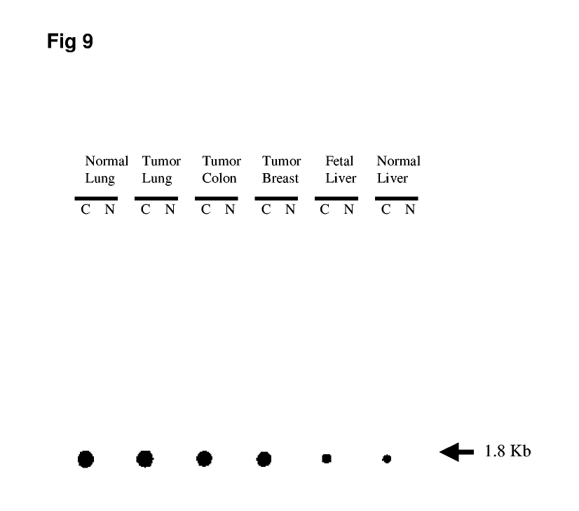

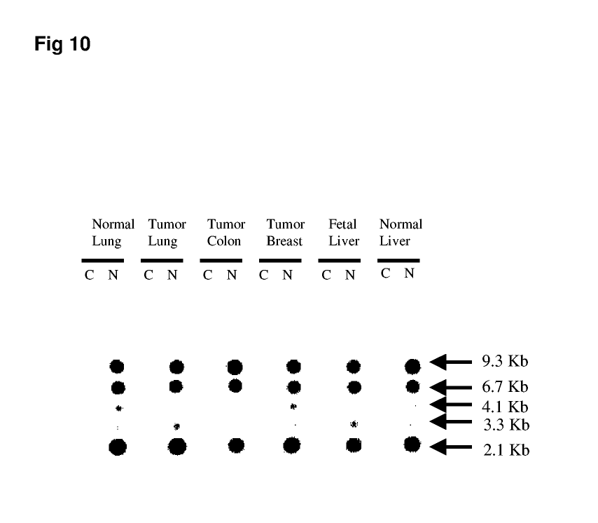

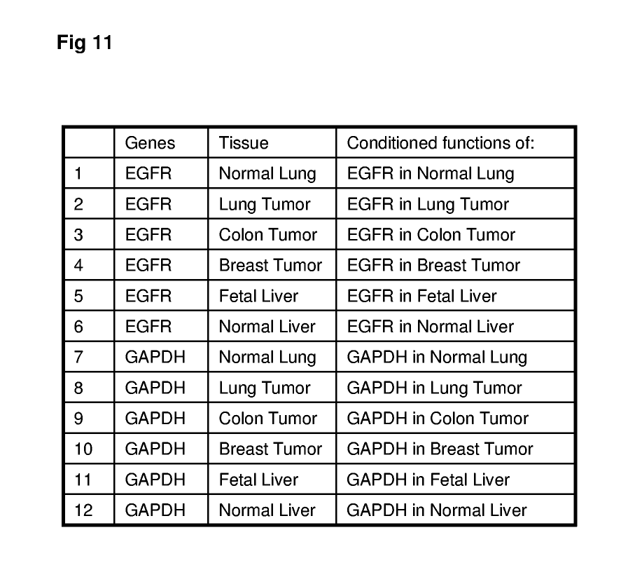

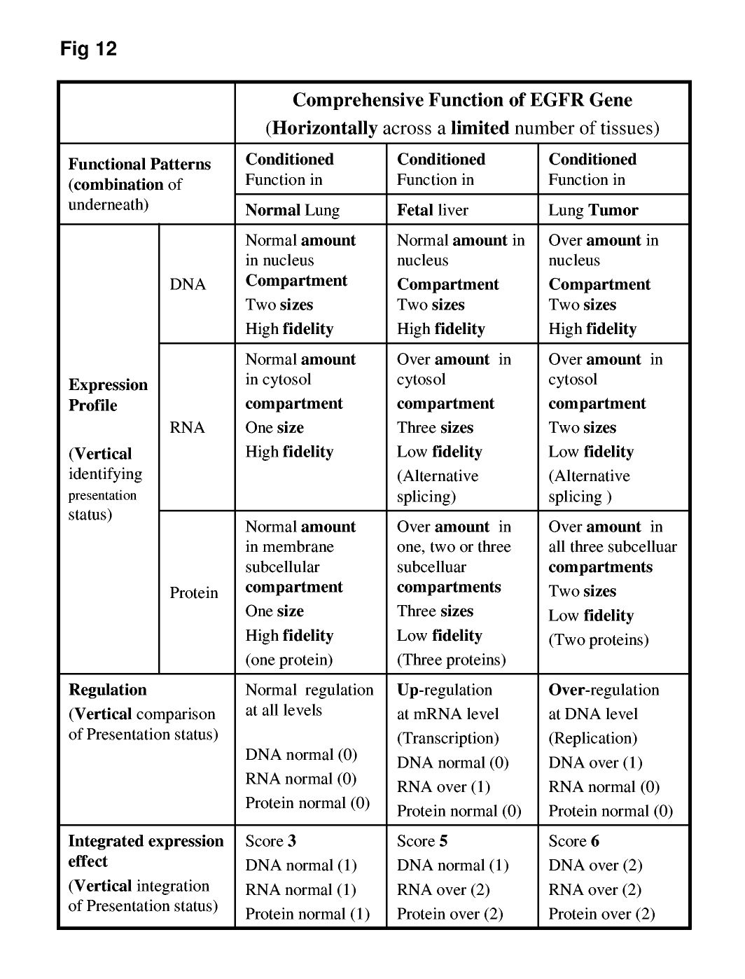

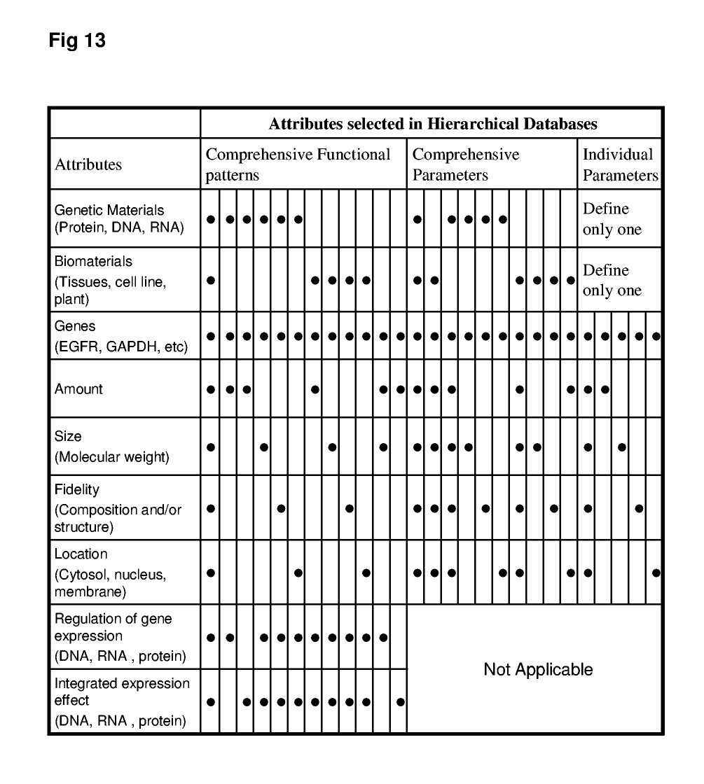

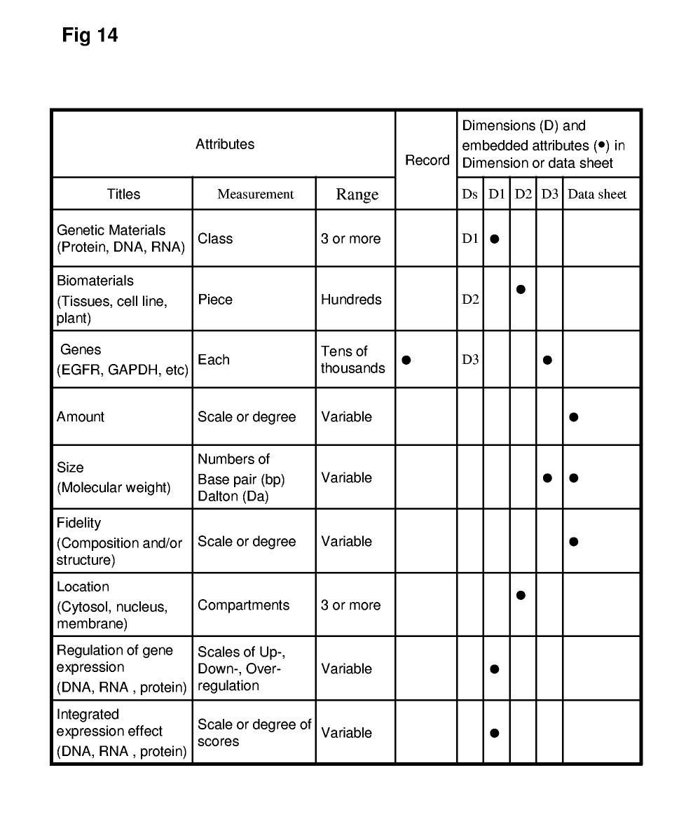

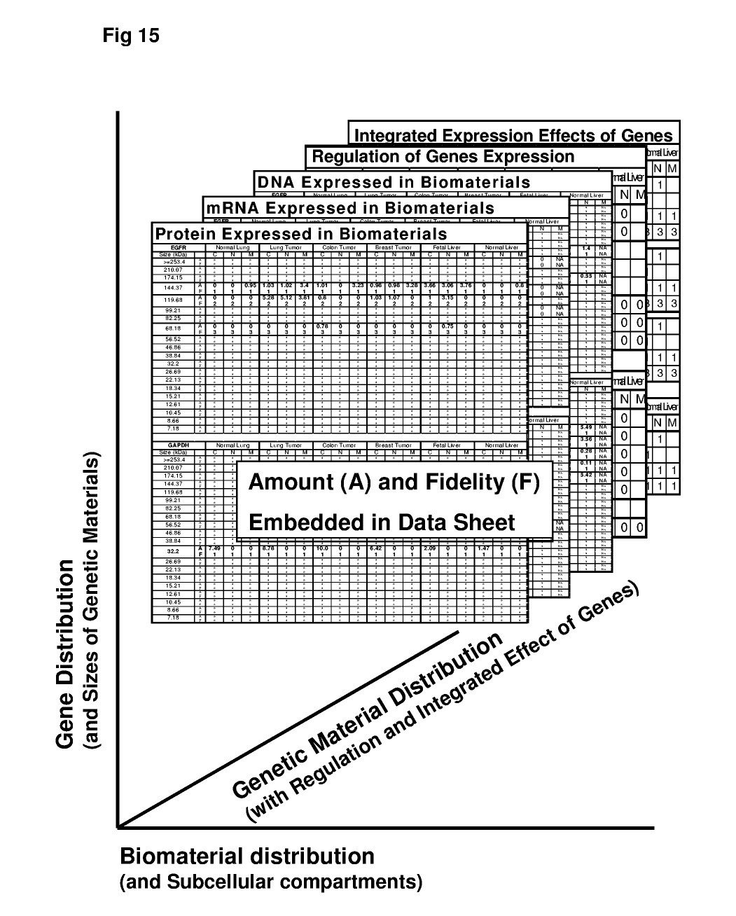

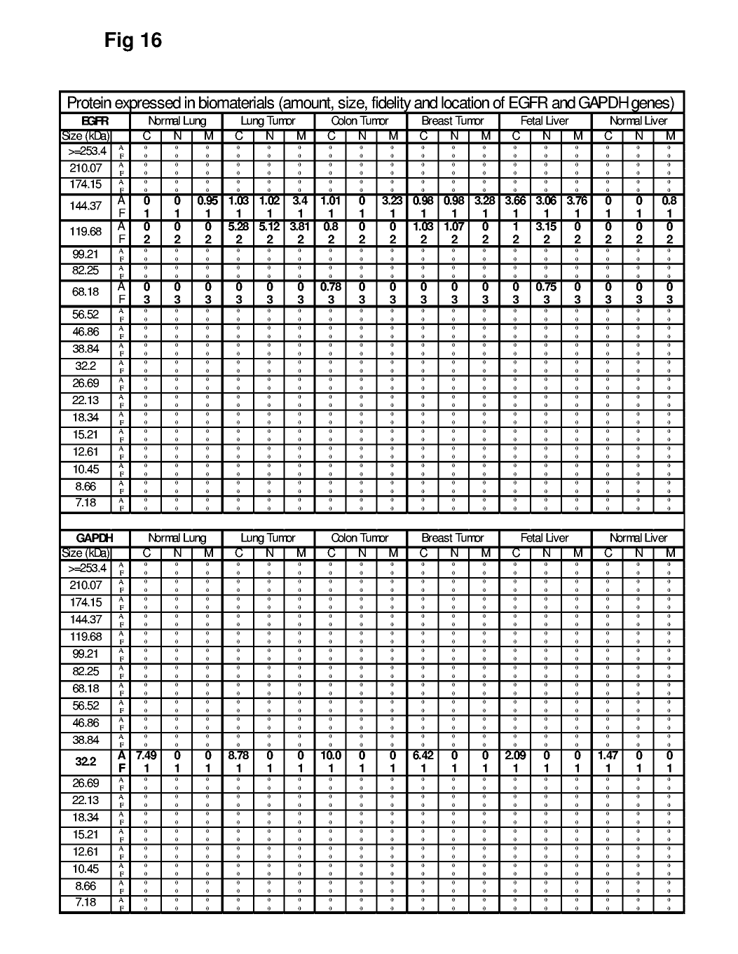

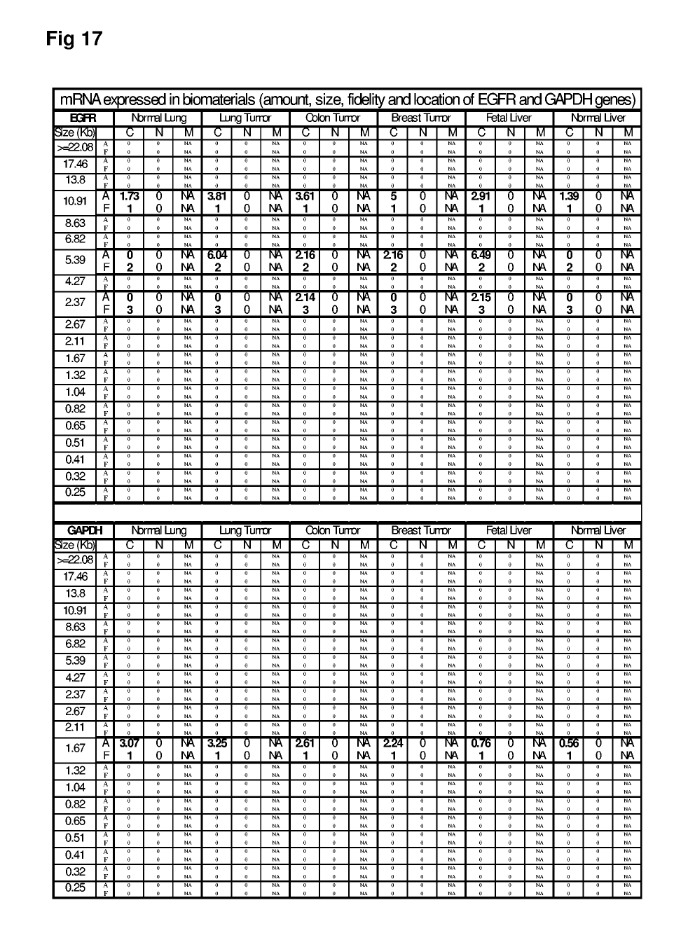

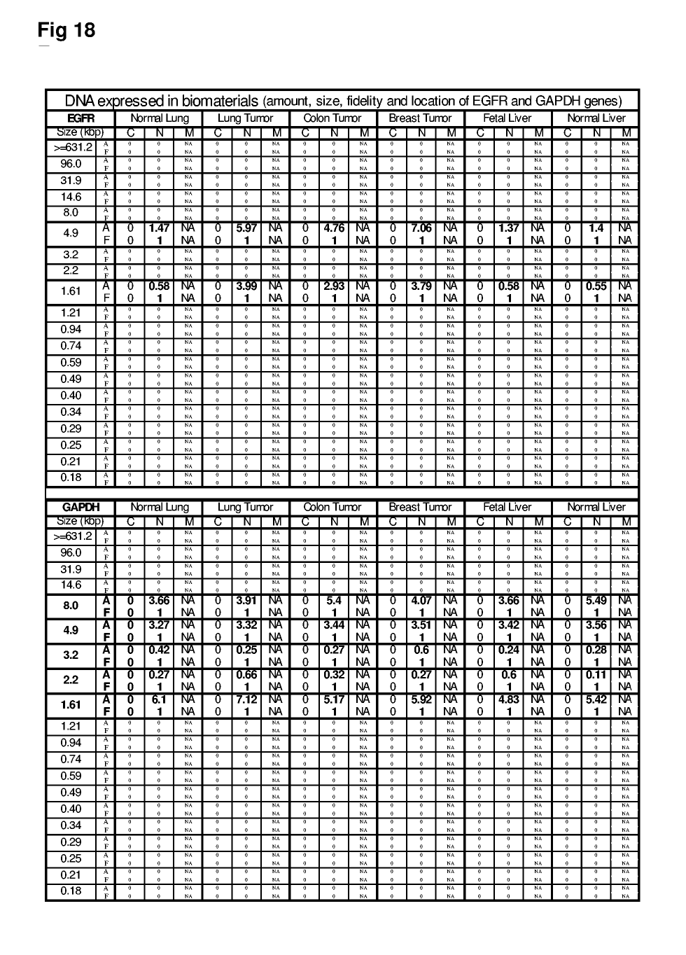

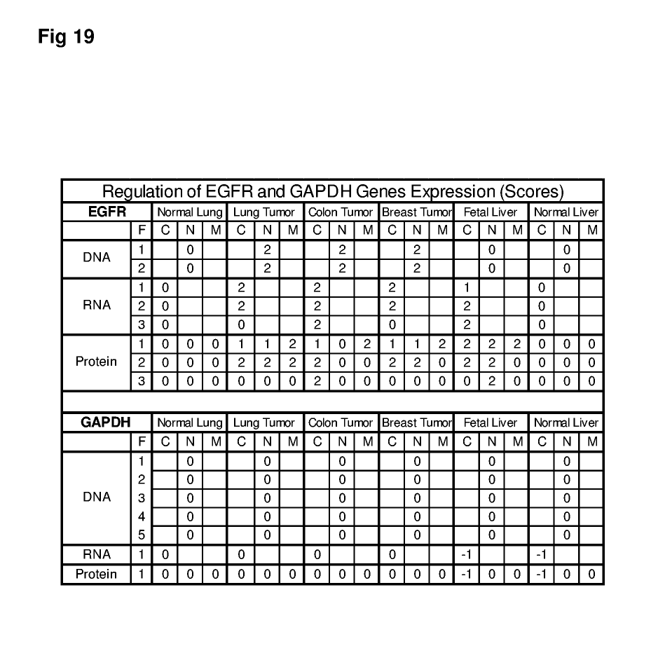

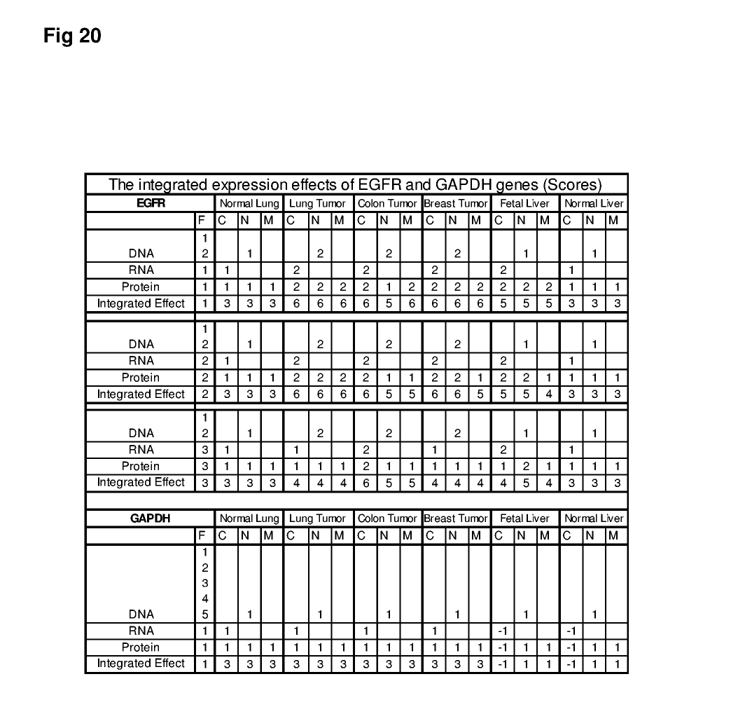

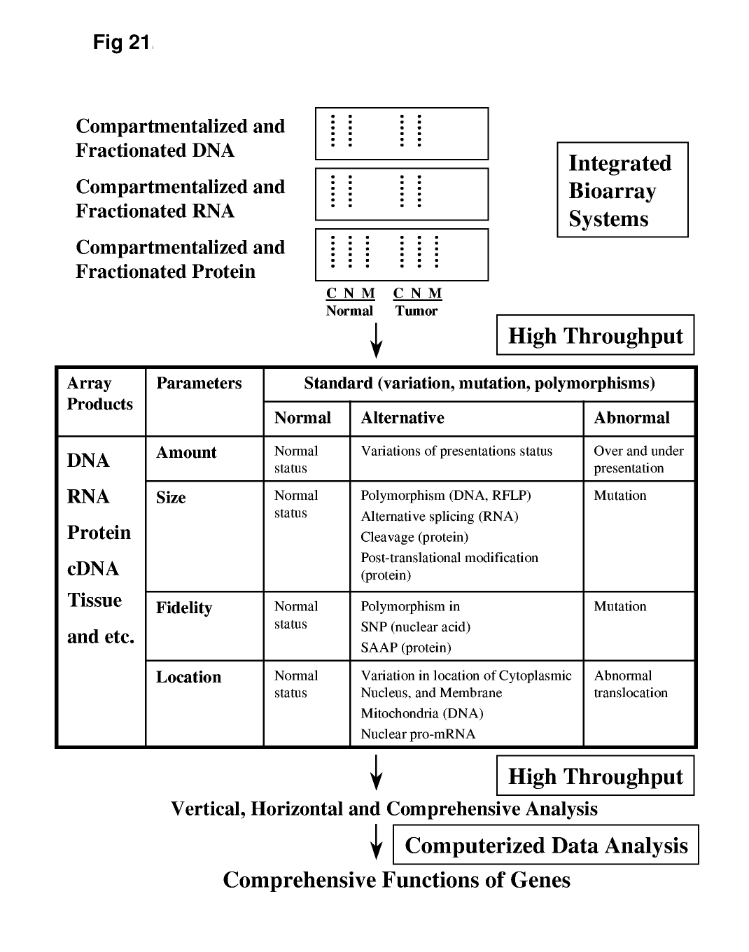

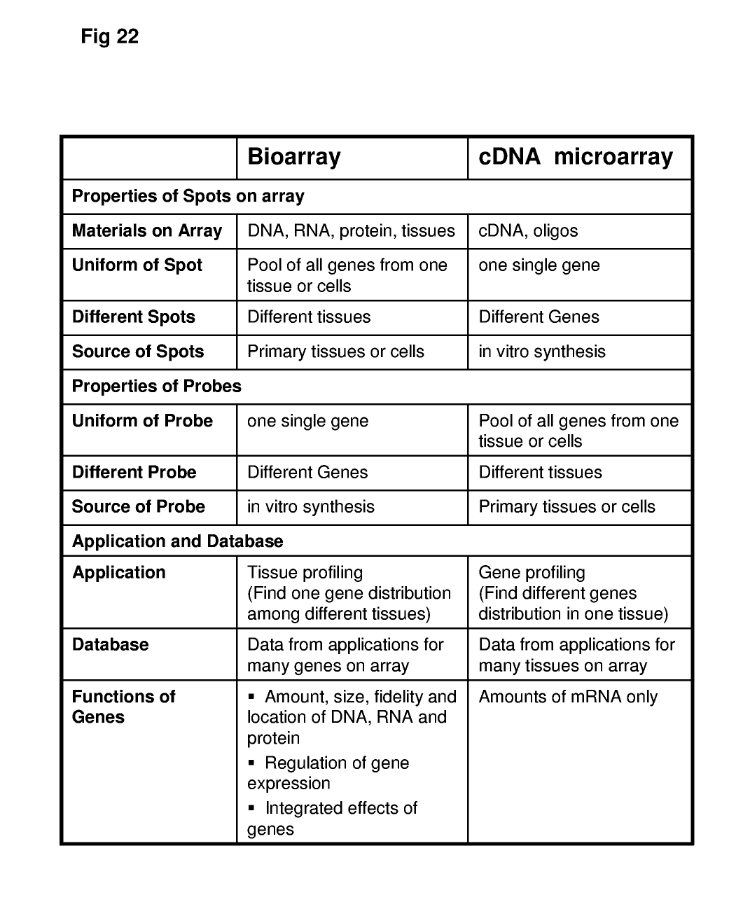

RNA specimens on RNA array product are isolated from subcellular compartments of six different tissues and fractionated. EGFR cDNA probe is applied on this RNA array product to detect expression of EGFR RNA. EGFR RNA is expressed very differently among human normal adult tissue, human fetal tissue and human tumor tissues. RNA with three different molecular sizes is corresponding to the proteins with three different molecular weights in FIG. 5.

FIG. 7. Expression of EGFR DNA detected on Integrated Bioarray System

DNA specimens on DNA array product are isolated from subcellular compartments of six different tissues and fractionated. Probe from partial cDNA of EGFR gene is applied on this DNA array product to detect expression of EGFR DNA. EGFR DNA is expressed very differently among human normal adult tissue, human fetal tissue and human tumor tissues. Two DNA fragments with different sizes come from the same EGFR genomic DNA by restriction enzyme digestion.

FIG. 8. Expression of GAPDH protein detected on Integrated Bioarray System

Protein specimens on protein array product are isolated from subcellular compartments of six different tissues and fractionated. Anti-GAPDH antibody is applied on this protein array product to detect expression of GAPDH protein. GAPDH proteins are expressed differently among human normal adult tissue, human fetal tissue and human tumor tissues in the same subcellular compartments with only one molecular weight.

FIG. 9. Expression of GAPDH RNA detected on Integrated Bioarray System

RNA specimens on RNA array product are isolated from subcellular compartments of six different tissues and fractionated. GAPDH cDNA probe is applied on this RNA array product to detect expression of GAPDH RNA. GAPDH RNA is expressed differently among human normal adult tissue, human fetal tissue and human tumor tissues with one molecular sizes corresponding to the protein in FIG. 9.

FIG. 10. Expression of GAPDH DNA detected on Integrated Bioarray System

DNA specimens on DNA array product are isolated from subcellular compartments of six different tissues and fractionated. Probe from partial cDNA of GAPDH gene is applied on this DNA array product to detect expression of EGFR DNA. EGFR DNA is expressed similarly among human normal adult tissue, human fetal tissue and human tumor tissues. Five DNA fragments with different sizes come from the same genomic DNA by restriction enzyme digestion.

FIG. 11. Twelve Conditioned Functions of EGFR and GAPDH in Six Tissues

Each set of conditioned functions of gene is the gene in one type of tissue under one condition. EGFR gene in normal lung tissue shows one set of conditioned functions of EGFR gene while EGFR gene in lung tumor tissue shows another set of conditioned functions of EGFR gene. Therefore, two genes in six different types of tissues show twelve sets of conditioned functions of genes.

FIG. 12. The Comprehensive Functions of EGFR Gene

The Comprehensive Functions of EGFR Gene are a selection of conditioned functions of EGFR gene in many different tissues. This figure shows three sets of conditioned functions of EGFR gene in three different tissues, normal adult lung tissue, fetal liver tissue, and lung tumor tissue. Each set of conditioned functions of EGFR gene consists of expression profile, regulation of gene expression and integrated expression effect of EGFR gene. Every set of conditioned functions of EGFR gene is different from each other. Comprehensive analysis of every set of conditioned functions of EGFR gene horizontally across different tissues will annotate the comprehensive functions of EGFR gene.

FIG. 13. Hierarchies of Databases and Attributes selected in Hierarchical Databases for Comprehensive Function of Genes

There are nine attributes in the database for comprehensive functions of genes. The more attributes selected in database, the higher is the hierarchy of database. The database with attributes of regulation of gene expression and integrated expression effect is considered with higher hierarchy and, thus, defined as database for comprehensive functional patterns of genetic materials; the database without attributes of regulation of gene expression and integrated expression effect but with attributes of genetic materials and biomaterials is considered at middle hierarchy and, thus, defined as database for comprehensive parameters of genetic materials; and the database without attributes of regulation of gene expression and integrated expression effect, and without attributes of genetic materials and biomaterials is considered at lower hierarchy and, thus, defined as database for individual parameters of genetic materials. There are more combinations of attributes in databases than what are listed in this table.

FIG. 14. Architectures of Three-dimensional databases with Nine Attributes for Comprehensive Functions of Genes

Three-dimensional databases with nine attributes are at highest hierarchy of databases. There are nine attributes in this database but it is organized as a database with three major attributes or dimensions. The three attributes served as dimensions are: 1) genetic materials distribution (D1), such as DNA, RNA and protein: 2) biomaterials distribution (D2), such as different tissues; and 3) genes distribution (D3), such as DNA, RNA or protein from different genes. The other six attributes are embedded either inside datasheet or inside dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials. A set of conditioned functions of a gene is a record for this database.

FIG. 15. Three-dimensional Database with Nine Attributes For Annotating the Comprehensive Functions of Genes

There are nine attributes in this database but it is organized as a database with three major attributes or dimensions. The three attributes served as dimensions are: 1) genetic materials distribution, such as DNA, RNA and protein; 2) biomaterials distribution, such as different tissues; and 3) genes distribution, such as DNA, RNA or protein from different genes. The other six attributes are embedded either with datasheet or within dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials.

There are five datasheets in this database: 1) protein expressed in biomaterials; 2) mRNA expressed in biomaterials; 3) DNA expressed in biomaterials; 4) regulation of gene expression; and 5) integrated expression effects of genes. Letter A in datasheet represents amount of genetic materials and F stands for fidelity of genetic materials. C, N, and M stand for subcellular compartments of cytosol, nucleus, and membrane respectively.

FIG. 16. Datasheet of EGFR and GAPDH Protein Expressed on Protein Array Product

This is a datasheet of protein expressed in biomaterials, one of five datasheets in three-dimensional database. This datasheet contains six attributes: 1) amounts of protein; 2) size of protein; 3) fidelity of protein; 4) location of protein; 5) biomaterials or tissues; and 6) genes.

Amount (A) of protein in datasheet is shown as digitized data by scanning signal image and quantitated using a computer. Left column shows the sizes of protein in each specimen. Fidelity (F) is scored as numbers for illustration only, which may not be accurate or complete. Fidelity of protein scored as 1 is presented in most of the population or normal status; score of 2 is a variant of the normal status; and score of 3 is another variant of the normal status. Locations of protein are indicated as subcellular compartments of cytosol (C), nucleus (N), and membrane (M). Upper half and lower half of datasheet show data of EGFR and GAPDH protein respectively in six different tissues.

FIG. 17. Datasheet of EGFR and GAPDH mRNA Expressed on RNA Array Product

This is a datasheet of mRNA expressed in biomaterials, one of five datasheets in three-dimensional database. This datasheet contains six attributes: 1) amounts of mRNA; 2) size of mRNA; 3) fidelity of mRNA; 4) location of mRNA; 5) biomaterials or tissues; and 6) genes.

Amount (A) of mRNA in datasheet is shown as digitized data by scanning signal image and quantitated using a computer. Left column shows the sizes of mRNA in each specimen. Fidelity (F) is scored as numbers for illustration only, which may not be accurate or complete. Fidelity of mRNA scored as 1 is presented in most of the population or normal status; score of 2 is a variant of the normal status; and score of 3 is another variant of the normal status. Locations of mRNA are indicated as subcellular compartments of cytosol (C), nucleus (N), and membrane (M). Upper half and lower half of datasheet show data of EGFR and GAPDH mRNA respectively in six different tissues.

FIG. 18. Datasheet of EGFR and GAPDH DNA expressed on DNA Array Product

This is a datasheet of DNA expressed in biomaterials, one of five datasheets in three-dimensional database. This datasheet contains six attributes: 1) amounts of DNA; 2) size of DNA; 3) fidelity of DNA; 4) location of DNA; 5) biomaterials or tissues; and 6) genes.

Amount (A) of DNA in datasheet is shown as digitized data by scanning signal image and quantitated using a computer. Left column shows the sizes of DNA in each specimen. Fidelity (F) is scored as numbers for illustration only, which may not be accurate or complete. Fidelity of DNA scored as 1 is presented in most of the population or normal status; score of 2 is a variant of the normal status; and score of 3 is another variant of the normal status. Locations of DNA are indicated as subcellular compartments of cytosol (C), nucleus (N), and membrane (M). Upper half and lower half of datasheet show data of EGFR and GAPDH DNA respectively in six different tissues.

FIG. 19. Datasheet for Regulation of EGFR and GAPDH Gene Expression at DNA, RNA and Protein Level

This is a datasheet of regulation of EGFR and GAPDH gene expression, one of five datasheets in three-dimensional database. This datasheet contains six attributes: 1) regulation of gene expression; 2) fidelity of genetic materials; 3) location of genetic materials; 4) genetic materials; 5) biomaterials or tissues; and 6) genes.

Regulations of gene expression in datasheet are shown as scores. The scores are for illustration only, which may not be accurate or complete. Regulation of DNA, RNA or protein scored as 0 is the regulation status presented in most of the population or normal status; score of 1 is for up-regulation and score of 2 is for over up-regulation; score of −1 is for down-regulation. Fidelity (F) is scored as numbers for illustration only, which may not be accurate or complete. Fidelity of DNA, RNA or protein scored as 1 is presented in most of the population or normal status; score of 2 is a variant of the normal status; and score of 3 is another variant of the normal status. Locations of DNA are indicated as subcellular compartments of cytosol (C), nucleus (N), and membrane (M). Left column shows the genetic materials. Upper half and lower half of datasheet show data of regulation of EGFR and GAPDH gene expression respectively in six different tissues.

FIG. 20. Datasheet for Integrated Expression Effects of DNA, RNA and Protein from EGFR and GAPDH Genes

This is a datasheet for integrated expression effects of EGFR and GAPDH gene, one of five datasheets in three-dimensional database. This datasheet contains six attributes: 1) integrated expression effects of gene; 2) fidelity of genetic materials; 3) location of genetic materials; 4) genetic materials; 5) biomaterials or tissues; and 6) genes.

Integrated expression effects of genetic materials in datasheet are shown as scores. The scores are for illustration only, which may not be accurate or complete. Integrated expression effects of DNA, RNA or protein scored as 1 is the effect status presented in most of the population or normal status; score of 2 is for the effect stronger than that in most of the population or normal status; score of −1 is for the effect weaker than that in most of the population or normal status. Scores for integrated expression effect are the sum of scores for effect of DNA, RNA, and protein. Fidelity (F) is scored as numbers for illustration only, which may not be accurate or complete. Fidelity of DNA, RNA or protein scored as 1 is presented in the most population or normal status; score of 2 is a variant from most of the population; and score of 3 is another variant from most of the population. Locations of DNA are indicated as subcellular compartments of cytosol (C), nucleus (N), and membrane (M). Left column shows the genetic materials. Upper half and lower half of datasheet show data of the integrated expression effect of EGFR and GAPDH genes respectively in six different tissues.

FIG. 21. Converting Information of Genetic Materials into Data to Annotating the Comprehensive Functions of Genes

The segregated and fractionated genetic information or data of DNA, RNA and protein from the same piece of biomaterials are detected and collected by the high throughput and integrated bioarray system. The segregated pools of genetic information are converted into isolated data in the format of parameters and standards. The relationship or interaction of genetic information or data among DNA, RNA and protein is revealed by vertical analysis of the parameters and standards. The regulation of gene and protein expression and integrated expression effects of genes are additional and valuable data created by vertical analysis of the parameters and standards. The horizontal and comprehensive analysis the parameters and standards illustrate comprehensively the different functions of a gene in different tissues under different conditions.

The vertical and horizontal analyses of the parameters and standards of related genes are performed simultaneously to reveal the influence on functions of the gene by interactions between genes. The repetition of horizontal and comprehensive analysis of many different tissues for different genes will generate a large three-dimensional database. The comprehensive functions of genes are annotated by computerized database analysis of the three-dimensional database or manually. Revealing information or data of DNA, RNA and protein simultaneously, vertical analysis and horizontal analysis of the information or data of DNA, RNA and protein across different biomaterials for different genes are three key processes in this invention for converting the information of genetic materials into data to annotate the comprehensive functions of genes.

FIG. 22. A Comparison of BioChain's bioarray with conventional cDNA Microarray

This figure shows the fundamental difference between the high throughput and integrated bioarray system in this invention and conventional cDNA mircoarray. First, materials on array products are different. Every spots of genetic materials on integrated bioarray system are the pooled products of genes from primary tissues or cell lines while that on conventional cDNA microarray are cDNA from a single gene. Second, Probe used on integrated bioarray system is a single gene whereas that on conventional cDNA microarray is a pooled product of genes from a single piece of tissues or a specific cell line. Third, application of integrated bioarray system identifies tissue profiling of a single gene, or finds one gene distributing among different tissues; application of conventional cDNA microarray identifies gene profiling in a single tissue, or finds different genes distributing in a tissue.

Above all, the high throughput and integrated bioarray system in this invention can annotate the comprehensive functions of genes by analyses of expression profiles including amounts, sizes, fidelity and location of DNA, RNA and protein; analyses of regulation of gene expression; and analyses of integrated expression effects of genes, while conventional cDNA microarray can only analyze amounts of RNA at the isolated segment of machinery of gene functions. Therefore, the high throughput and integrated bioarray system in this invention can annotate the comprehensive functions of genes, while conventional cDNA microarray can only provide some isolated hints about function of genes.

### DETAILED DESCRIPTION OF THE INVENTION

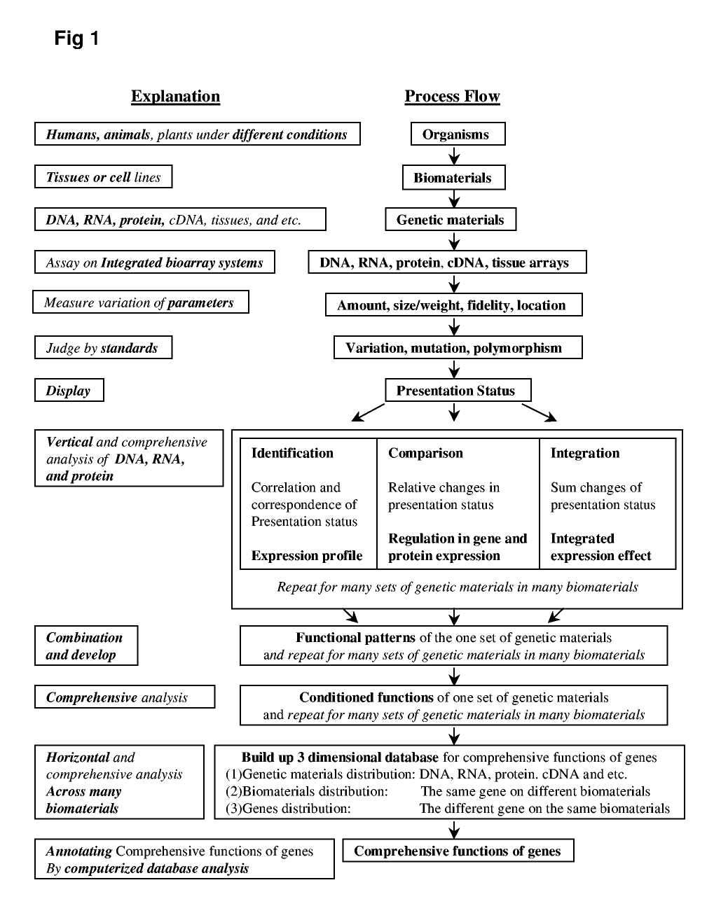

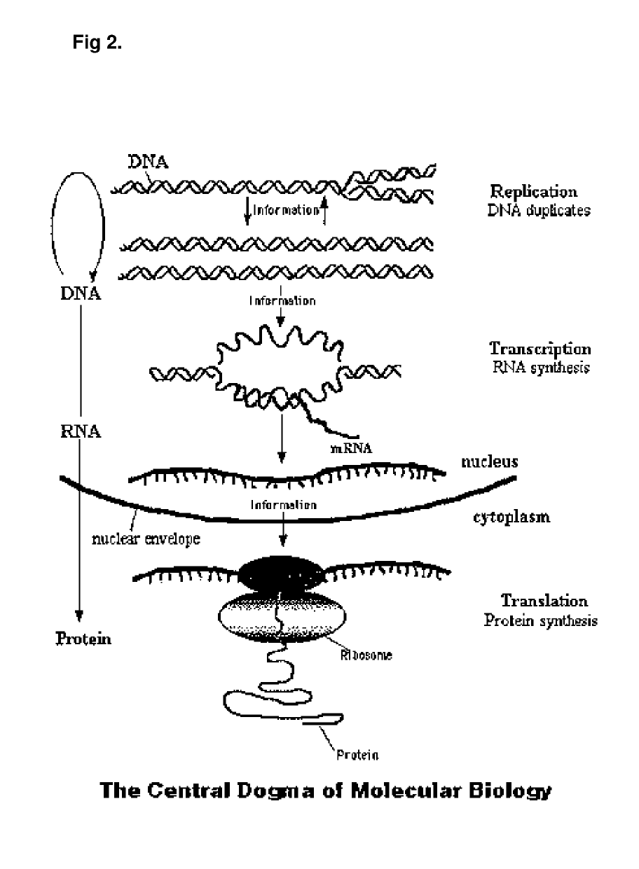

Francis Crick proposed The Central Dogma of molecular biology in 1957 and it states that the information is transmitted from DNA and RNA to proteins, but information cannot be transmitted from a protein to DNA as illustrated in FIG. 2. Functional genomics is the study of gene expression starting from the regulation of transcription to protein structure and functions in a high throughput manner. A schematic presentation of gene expression process is shown in FIG. 1.

There are multiple levels of regulation for the expression of each gene. To start with, the DNA in a cell may already carry mutations or other lesions that will lead the tissue susceptible to mutagenesis or the tissue will ultimately develop certain disease. It is important to understand the effects of genomic DNA alterations on certain diseases. Transcription of the information in DNA sequences to mRNA is a critical step for gene expression regulation and it is most efficient. Nuclear proteins including transcription factors play critical roles at this process. Nuclear proteins from different tissues can provide information on the scenario of the activity of transcription of that particular tissue. Certainly, the relative amount of each mRNA species in a certain cell or tissue is the outcome of transcription and the nature of the mRNA that determines the decay of itself. cDNA microarray and Northern blot analysis are two common technologies that can determine the level of mRNA expression. mRNA serves as a template for protein synthesis and the process is called translation. Translational control is another way cells use to regulate gene expression. It is fast and precise since it is directly linked to functional proteins. Once proteins are made, they are transported to different subcellular locations and function differently among each other. Post-translational regulation of proteins can provide another mechanism in regulate protein activity and stability.

To better describe and present the current invention, some concepts or definitions are introduced or created herein. The examples of these concepts or definitions are biomaterials; the genetic materials; fractionated genetic materials; compartmentalized genetic materials; one set of genetic materials; one selection of biomaterials; one group of genetic materials; the designated order; the array; the array product; integrated bioarray system; the analysis platform; high throughput; the dynamic, complicated, interactive and integrated activities in genetic materials; the comprehensive functions of genes; the fluctuation in the activities of protein, RNA, DNA, and etc.; the functions of genes; the parameters for measuring fluctuations of activities in genetic materials; the amount, size or molecular weight, fidelity of sequence, and locations of genetic materials; the major standards for judging the parameters; the variations, mutations or polymorphisms in amount, size or molecular weight, fidelity of sequence, and locations of genetic materials; the polymorphisms; the variations in length or fidelity of genetic materials; presentation statuses; the vertical and comprehensive analysis of the presentation statuses; the vertical identification of the correlation and correspondence among the presentation status; the expression profile; the vertical comparison of relative changes of the presentation status; the regulation in gene expression; the vertical integration of sum changes of the presentation status; integrated expression effect; the combination of the expression profile, regulation in gene expression, and integrated expression effect of DNA, RNA, protein and etc; the functional patterns; the conditioned functions of the gene; the horizontal and comprehensive analysis of the functional patterns across different biomaterials under different conditions; the limited or completed three-dimensional database for the comprehensive functions of genes; hierarchical database; attributes of database; the records of database; the entry of database; the genetic materials distribution; the biomaterial distribution; the gene distribution; The limited or completed comprehensive functions of genes. These concepts or definitions are explained in detail as follows.

Biomaterials refer to the materials from biological organisms, such as tissues, cell lines, plant, and etc. The genetic materials are materials isolated from the biomaterials, such as DNA, RNA and protein, or processed materials such as cDNA, and etc. Fractionated genetic materials are materials separated by methods such as gel electrophoresis and recovered according to the size or molecular weight. Compartmentalized genetic materials are materials isolated from their subcellular locations. One set of genetic materials includes DNA, RNA, proteins, cDNA, tissues and etc from one piece of biomaterials. One selection of biomaterials includes many different biomaterials under different conditions. One group of genetic materials contains one type of genetic materials such as DNA or RNA from one selection of biomaterials. The designated order is a specific arrangement of one group of genetic materials. The array is a group of genetic materials arranged specifically according to the designated order. The array product is a group of genetic materials such as DNA or RNA immobilized onto supporting materials or stored in holding materials. Integrated bioarray system is a combination of different array products, such as DNA array product, RNA product, and protein array product, in which DNA, RNA and protein are isolated from the same selection of biomaterials. The analysis platform consists of integrated bioarray system, detection technologies, and computerized database analysis to annotating comprehensive functions of gene in high throughput manner.

The concept or definition of functions of genes can be as simple as the functions of proteins acted by genes, or can be as complicated as the functions involving many aspects of the dynamic, complicated, interactive and integrated activities in genetic materials, such as DNA, RNA, proteins, and etc. Therefore, we deliberately name the complicated concept of functions of genes as the comprehensive functions of genes, which are the comprehensive activities of the DNA, RNA protein, and etc. as described above. The comprehensive functions of genes herein focus on the comprehensive activities revealed by vertical and comprehensive analysis of the presentation statuses of DNA, RNA, protein, and etc. (presented as expression profile, regulation in gene expression, and integrated expression effect) plus horizontal and comprehensive analyzing them across different biomaterials under different conditions as described later. The activities of the protein, RNA DNA, and etc. are very fluctuated in different status of organisms, such as in diseases or tumors. Thus, the functions of the gene are also very fluctuated and usually shown as fluctuations in replication of DNA for this gene, fluctuations in transcription from DNA into RNA for this gene, fluctuations in translation from RNA into protein for this gene, fluctuations in modification of the protein for this gene after translation, fluctuations in protein function for this gene, and etc. under different circumstances. Based on the above knowledge, the functions of genes should be considered as comprehensive effects of dynamic, complicated, interactive and integrated activities of protein, RNA and DNA. Therefore, concept of the comprehensive functions of genes is preferred herein to describe the functions of genes.

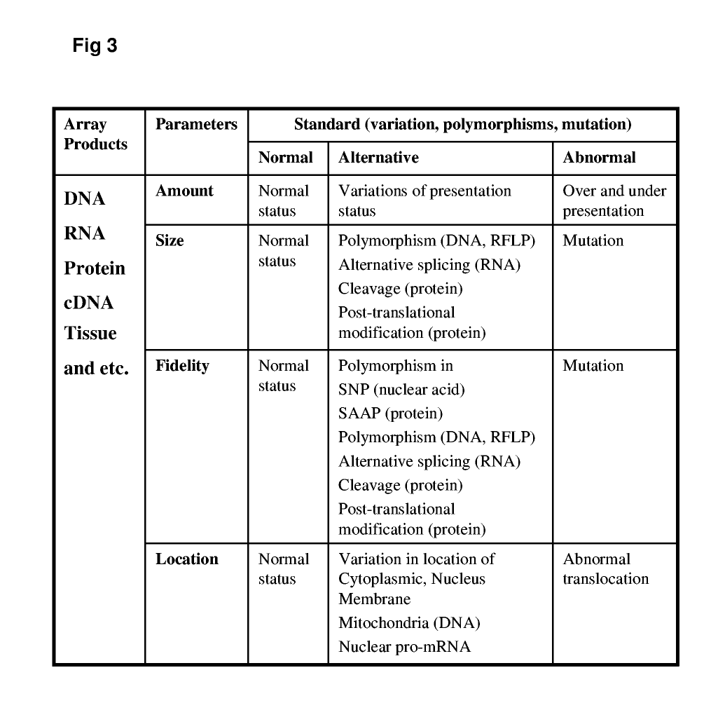

The parameters for measuring fluctuations of activities in genetic materials are the amount, size or molecular weight, fidelity of sequence, and locations of genetic materials. The amount of genetic materials refers to numbers of DNA copies, number of RNA transcripts, or amount of translated proteins from the genes. The size or molecular weight of genetic materials represents the number of nucleotides in DNA or RNA, and number of amino acid residues of proteins. The fidelity of sequence of genetic materials reflects the alteration, replacement or exchange of nucleotides in DNA or RNA, and of amino acid residues in proteins. The locations of genetic materials indicate the position of DNA, RNA, and proteins at subcelluar compartments, such as cytosol, nucleus or membrane. The four parameters are summarized in FIG. 3.

The major standards for judging the parameters as described above are the variations, mutations or polymorphisms in amount, size or molecular weight, fidelity of sequence, and locations. The variation, mutation or polymorphisms are the fluctuations around popular or normal status of activities in genetic materials. Generally speaking, the mutation is the changes that cause abnormal status of organisms while polymorphisms are the changes that do not cause abnormal status of organisms. The variations include mutation, polymorphisms, normal status, and some unknown consequences that variations may cause. The three standards are summarized in FIG. 3.

The well-known examples for the polymorphisms are the variations in length or fidelity of genetic materials. The variations in length of gene materials include, but not limited, variations of fragments of genes (restriction fragment length polymorphism, RFLP in DNA or alternative splicing in RNA) and alternative cleavage of proteins or post-translational modification of protein. The variations in fidelity of gene materials include, but not limited, variation of a single nucleotide in genes (single nucleotide polymorphism, SNP in DNA or RNA) or a single amino acid in proteins (single amino acid polymorphism, SAAP). Mutations are the extreme situation of polymorphisms, which cause obvious malfunction of genetic materials and eventually abnormality of organisms.

The presentation statuses of genetic materials displays the variations of parameters for activities of genetic materials detected and collected from different assays such as integrated bioarray system. One single gene will lead to one set of genetic materials with different characteristics, such as molecules of DNA, RNA, protein or cDNA from actin gene. The activities from one set of genetic materials will display one set of presentation statuses, including presentation statuses of DNA, of RNA, of protein, or of cDNA. The presentation statuses of genetic materials convert information of variations in activities of genetic materials into qualitative and quantitative data by application of parameters and standards. The presentation statuses of genetic materials only document isolated data representing the variations of parameters, but relationship of these parameters, especially the parameters from different genetic materials such as from DNA, RNA and protein, is not illustrated.

The relationship among different presentation statuses of DNA, RNA, and protein from one piece of biomaterials is analyzed by vertical process. The process of DNA transcribed to RNA and RNA translated to protein is defined herein as the vertical process that is the process of central dogma. Three vertical processes of vertical identification, vertical comparison and vertical integration are applied on the presentation statuses of DNA, RNA, and protein, and expression profiles, regulations in gene and protein expression, and integrated expression effect are extracted or created respectively. The expression profiles from one set of genetic materials are the correlation and correspondence among the presentation status of genetic materials identified vertically according to above standards and the parameters of variations in DNA, RNA, protein, cDNA, tissue, and etc. Regulations in gene and protein expression are analyzed based on central dogma. By vertical comparison among the relative changes of presentation status in DNA, RNA, protein, cDNA, tissue, and etc. in the same biomaterials, regulations in gene and protein expression can be reasoned and clarified according to central dogma. The integrated expression effect is the result of vertical integration on sum changes of presentation status in DNA, RNA, protein, cDNA, tissue, and etc., in the same biomaterials. Thus, the expression profiles, the regulations in gene and protein expression, and the integrated expression effect of genetic materials are the results of the vertical and comprehensive analysis on identification, comparison, and the integrations of the presentation status in DNA, RNA, protein, cDNA, tissue, and etc.

The functional patterns are developed by combination of the expression profiles, regulations in gene and protein expression, and the integrated expression effect from one set of genetic materials, such as DNA, RNA, proteins, cDNA, tissues and etc. The vertical and comprehensive analysis of DNA, RNA and protein is the key process to develop the components for functional patterns, such as the regulations in gene and protein expression and the integrated expression effect of genetic materials according the presentation status of genetic materials. Thus, the functional patterns from one set of genetic materials reveal the expression profile, regulation in expression, and integrated expression effect of DNA, RNA, protein, cDNA, tissue, and etc from a single gene. One set of genetic materials may reveal a selection of the functional patterns if it is applied on a selection of many pieces of biomaterials under different conditions. Multiple genes will produce multiple sets of the functional patterns on the same piece of biomaterial.

As mentioned early that the comprehensive functions of gene herein include the major activities of DNA, RNA, protein and etc., such as the expression profile, regulation in expression, and integrated expression effect of DNA, RNA protein, and etc. The functional patterns of genetic materials herein have illustrated these major activities of DNA, RNA, protein and etc. Activities of a single gene and its genetic materials develop a set of specific functional patterns in a piece of analyzed biomaterial. A comprehensive analysis must be performed on the set of the specific functional patterns generated by one set of genetic materials to annotate the conditioned functions of the gene in the piece of analyzed biomaterial. The reason is that activities of expression profile, regulation in expression and integrated expression effect of one set of genetic materials should function biologically and correspond to each other logically. The same set of genetic materials may reveal a selection of different conditioned functions of the gene if it is applied on a selection of many pieces of biomaterials under different conditions. Comprehensive analysis performed on multiple sets of the specific functional patterns from multiple sets of genetic materials (multiple genes) will annotate multiple sets of the conditioned functions for many genes on the same piece of biomaterial.

The multiple functional patterns of one set of genetic materials (one gene) that developed from a selection of many pieces of biomaterials generate a selection of the conditioned functions of the gene. There can be many different conditioned functions for the same gene in different pieces of biomaterials under different conditions. Thus, a horizontal and comprehensive analysis must be performed on the selection of the conditioned functions of the gene (one set of genetic materials or one gene) to accumulate the data for the comprehensive functions of the gene in the multiple pieces of analyzed biomaterials. The reason is that conditioned functions of gene (one set of genetic materials) in different pieces of biomaterials under different conditions, such as under development, tumor, inflammation, or other disease conditions, can be different. These differences among the selection of different conditioned functions of the gene determine the comprehensive functions of the gene. For examples, a specific gene highly expressed in both tumor and inflammation conditions cannot be considered as tumor specific gene if one only has the data of conditioned functions of this gene in tumor condition without the data under inflammation condition. Therefore, horizontal and comprehensive analysis the conditioned functions of the gene across different pieces of biomaterials under different conditions are a necessary step to accumulate the data for the comprehensive functions of the gene.

In addition, in order to consider influence on functions of gene by interactions between genes, the comprehensive functions of all related genes should be analyzed simultaneously also. The outcome is that repetition of horizontal and comprehensive analysis of many different tissues (A) for all related genes (B) will generate a large numbers of sets (A×B=C) of the conditioned functions for all different genes. Further more, repetition of the horizontal and comprehensive analysis of all (n) different genes (all different sets of genetic materials) on all (m) the biomaterials will accumulate the data of the comprehensive functions for all genes in all biomaterials, which generate an even larger amount (n×m=p) of data. Therefore, in order to annotate accurately the comprehensive functions of genes, a computerized database analysis is necessary.

A three-dimensional database is constructed for these large numbers (A×B=C) or even larger numbers (n×m=p) of sets of the conditioned functions for all different genes. There are nine attributes in this database but it is organized as a database with three major attributes or dimensions. The three attributes served as dimensions are: 1) genetic materials distribution, such as DNA, RNA and protein; 2) biomaterials distribution, such as different tissues; and 3) genes distribution, such as DNA, RNA or protein from different genes. The other six attributes are embedded either within datasheet or within dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials.

Data from each set of conditioned functions of each gene are a record. Every isolated data is an entry such as a defined size of a specific protein in a tissue under a condition. Three-dimensional databases with nine attributes are at the highest hierarchy of databases. The databases at different hierarchies are constructed from many two-dimensional databases by many different combinations of above nine attributes as shown in FIG. 13. The hierarchies from high to low are in the order of databases for comprehensive functional patterns, for comprehensive parameters, and for individual parameters. Some combinations of three or more attributes from above nine attributes may lead to many different three-dimensional databases. The architectures of the three-dimensional databases in highest hierarchies are shown in FIGS. 14 and 15. This three-dimensional database can be used for annotating comprehensive functions of genes not only with large numbers of records, but also with limited numbers of records for annotating limited comprehensive functions of genes.

To further illustrate above three-dimensional database, one single gene will generate one set of genetic materials with different characteristics, such as DNA, RNA, protein or cDNA from EGFR or GAPDH gene, which forms the first dimension. In this dimension, distribution of genetic materials with different characteristics on the same piece of biomaterial is determined, which thus is called here as genetic materials distribution. One single gene of genetic materials such EGFR or GAPDH RNA can be distributed very differently on different pieces of biomaterials under different conditions, such as under development, tumor, inflammation, or other disease conditions, which is the second dimension or called here as biomaterial distribution. The third dimension is the distribution of different genes in the forms of DNA, RNA or protein on the same piece of biomaterial, in which different genes have the same characteristic, such as mRNAs from the same piece of biomaterial. Thus, the third dimension is called here as genes distribution. The term genes here as in genes distribution have been defined to a special meaning to represent any materials or molecules of DNA, RNA, protein, or etc. A gene represents also a specific gene from all populations of genes in the same piece of biomaterials, such as GAPDH mRNA from all populations of mRNA in a piece of lung tissue. The genetic materials distribution, biomaterial distribution, and genes distribution determine the three dimensions for the three-dimensional database that contains the data for the comprehensive functions of all genes in biomaterials.

It may not be possible sometimes to get the functional patterns of one set of genetic materials (one gene) from all different tissues under all different conditions, but it is quite possible to get a limited numbers of the functional patterns produced by one set of genetic materials (one gene) from a limited numbers of different tissues under a limited numbers of different conditions. The comprehensive functions of the gene based on a limited numbers of tissues under a limited numbers of conditions could be the limited comprehensive functions of the gene. However, it may not be necessary to get the functional patterns of one set of genetic materials (one gene) from all different tissues under all different conditions because the functional patterns from a representative numbers of tissues and conditions could be enough to determine the completed comprehensive functions of genes.

Finally, the comprehensive functions of genes will be annotated from the three-dimensional database for the comprehensive functions of genes by computerized database analysis. The more conditions of biomaterials a gene is analyzed under, the more comprehensive function of the gene is annotated. The more genes are analyzed, the more completed the database is. All the integrated information or data of all the functional patterns from all the genes in all the biomaterials under all the conditions forms the most comprehensive and completed three-dimensional database for the comprehensive functions of all genes. The computerized database analyses will expertise the process of annotation because it is a large database for the comprehensive functions of all genes. The comprehensive functions of any gene or all genes can be annotated from the three-dimensional database by vertical, horizontal, comprehensive, and computerized analysis across different biomaterials under different conditions.

Comprehensive functions of genes can be annotated by analysis the three-dimensional database either by computerized database analysis or manually. In most situations, there are not so many sets of the conditioned functions of the gene available for horizontal and comprehensive analysis. In addition, when horizontal and comprehensive analyses are performed on limited types of tissue under limited conditions, the resulting functions of the gene are considered as limited comprehensive function of the gene, which still explored and identified many extra functions of this gene. Moreover, considering influence on functions of a gene by interactions between different genes, the comprehensive functions of related genes should be analyzed simultaneously also. Therefore, comprehensive function of a gene can be annotated by horizontal and comprehensive analysis of representative sets of conditioned functions of related genes in representative types of tissue under representative conditions.

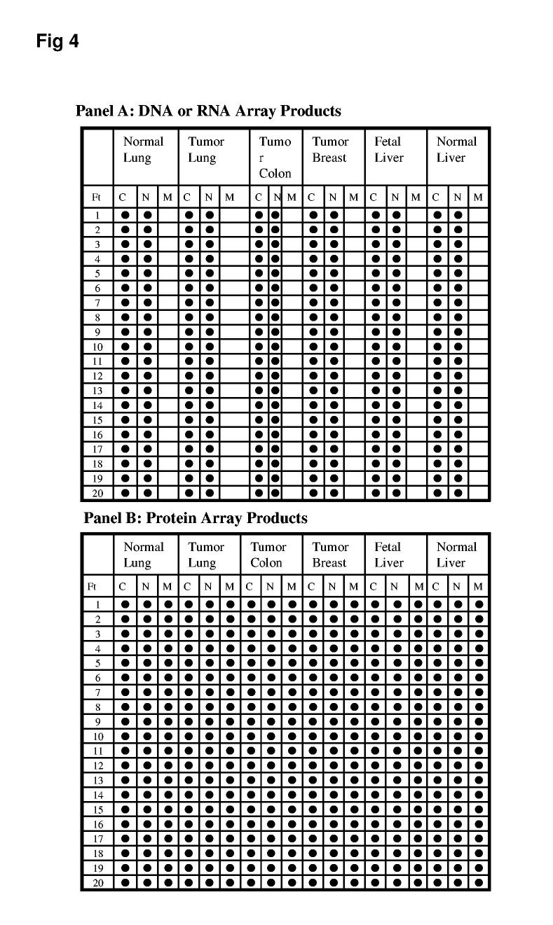

Toward above concepts and definitions, an integrated bioarray system is established in this invention to process genetic materials, such as DNA, RNA, protein, cDNA, tissue, and etc. from the same piece of biomaterial, in which many pieces of biomaterials can be processed simultaneously also. The integrated bioarray system is the integrated combination of DNA array products, RNA array products, protein array products, cDNA array products, tissue array products, and etc. made from the same selection of many pieces of biomaterials as illustrated in FIG. 4. Two genes and six different tissues are used as examples in this invention.

Two genes are selected as examples in this invention, epidermal growth factor receptor (EGFR) gene (AF288738) and glyceraldehydes-3-phosphate dehydrogenase (GAPDH) gene. The EGFR family consists of four closely related transmembrane receptors: EGFR (erbB1), erbB2 (HER2), erbB3 (HER3), and erbB4 (HER4). Cellular events after EGFR activation include the regulation of growth factor and cytokine directed gene expression and epigenetic events (cell adhension and cytoskeletal changes). EGFR is also expressed in many common tumors and it is closely related to the prognosis of the disease. Many antibodies and small molecule drugs are being tested as therapeutical means in treating a variety of cancers.

EGFR mRNA expression in patients may be or may not be accompanied by the same pattern of protein level. EGFR has three mutated forms. Of them variant III (EGFRviii) is the most common and it has a deletion of 268 amino acids at the extracellular domain. The domain contains a ligand binding site. When deleted, it confers the EGFRviii into a constant activated state without ligand binding. The subcellular localization of EGFR is found at cellular membrane as well as nucleus. Nuclear localization is believed to reflect the transcription factor role of EGFR.

Glyceraldehydes-3-phosphate dehydrogenase (GAPDH) is one of the most commonly used control genes in comparing gene expression. It is a housekeeping gene and is used as a loading control when Northern blot, Western blot, or microarray experiments are carried out. However, the relative amounts of GAPDH protein or mRNA expressed across different tissues are not always the same. They vary and are tissue specific. The relative amounts of GAPDH protein or mRNA expressed in the same type of tissues across different species are relatively constant. Up-regulation of GAPDH has been reported in many situations, such as cancer because the cancer cells has lost the gene expression profile of the original tissue that cancer cells developed from.

Six types of tissues as biomaterials are used as examples in this invention: normal adult lung tissue; lung tumor tissue; colon tumor tissue; breast tumor tissue; fetal liver tissue; and adult liver tissue. One set of specimens or genetic materials, such as DNA, RNA, proteins, cDNA, tissues and etc., is obtained from a single piece of biomaterial. From a selection of many pieces of biomaterials, the same selection of many sets of specimens or genetic materials is collected respectively and repetitively. Any set of specimens or genetic materials from the selection of many sets of specimens or genetic materials herein is corresponding to a designated piece of biomaterial.

Some specimens require biological processing before they can be applied in integrated bioarray system. For example, cDNA is synthesized from RNA and it may need to be fractionated and recovered. After isolated from tissues, genomic DNA is digested with certain restriction enzymes and fractionated on a gel. Different sizes of DNA fragment are then recovered from the gel as serial fractions.

Genomic DNA and cytosol DNA are isolated from nucleus and cytosol in subcellular compartments of six pieces of different tissues respectively. There are a total of 12 samples corresponding to compartmental DNA from six samples. 100 ug genomic DNA and cytosolic DNA are digested with 10 U/ug EcoRI or HindIII overnight at 37° C. DNA digested by EcoRI is used for assay of EGFR genes while DNA digested by HindIII is used for assay of GAPDH genes. The digests are separated on a 1% agarose gel. The gel containing digested and fractionated DNA is cut into 20 equal fractions with each fraction 5 mm in length. The fractionated DNA is recovered from gel fractions and dissolved in water.

Total RNA is isolated from nucleus and cytosol in subcellular compartments of six pieces of different tissues respectively. There are a total of 12 samples corresponding to compartmental RNA from six samples. Cytosolic total RNA and nuclear total RNA are recovered by phenol extraction method developed by BioChain. 100 ug RNA sample is fractionated on 1% denaturing agarose gel and the gel containing fractionated RNA is cut into 20 equal fractions with each fraction 5 mm in length. The fractionated RNA is recovered from gel fractions and dissolved in water.

Cytosol protein, nuclear protein and membrane protein are isolated from cytosol, nucleus and membrane in subcellular compartments of six pieces of different tissues respectively. Compartmental proteins are extracted from frozen tissue according to a method that has been developed at BioChain. There are a total of 18 samples corresponding to compartmental proteins from six samples. Each set of compartmental protein is composed of cytoplasmic protein, nuclear protein, and membrane protein. To fractionate proteins, 10 mg of each compartmental protein is separated on a preparative 4-20% gradient SDS-PAGE gel. After electrophoresis, the fractionated proteins are eluted out from 20 gel fractions and collected using a Bio-Rad Whole Gel Eluter. The eluted protein is further concentrated by centrifugation with Centricon tubes (Millipore).

The specimens or genetic materials are then rearranged according to their different characteristics, such as DNA, RNA, cDNA, proteins, tissues, and etc., into different groups of specimens or genetic materials, of which every specimen or genetic material in each group has the same characteristic, such as DNA, but come from different sets of specimens or genetic materials (from different pieces of biomaterials). Every group of specimens or genetic materials are arrayed in a designated order to convert every group of specimens or genetic materials in to arrays, such as DNA array, RNA array, cDNA array, protein array, tissue array, and etc. The designated orders for every arrayed specimen or genetic material on different arrays are recorded and used for corresponding every arrayed specimen or genetic material to each other on different arrays, as well as to every designated biomaterial in the selection of many pieces of biomaterials respectively.

The specimens in every array are immobilized onto or stored in the same supporting or holding materials in the designated order to make array products respectively, such as DNA array product, RNA array product, proteins array product, cDNA array product, tissues array product, and etc. In one embodiment, the specimens of fractionated and arrayed DNA are immobilized onto one piece of supporting materials, such as Hybond N+ nylon membranes, using a device from V & P Scientific to make DNA array product. Again, specimens of fractionated and arrayed RNA are immobilized onto another piece of supporting materials, such as Hybond N+ nylon membranes, using a device from V & P Scientific to make RNA array product. Specimens of fractionated and arrayed protein are immobilized onto the third piece of supporting materials, such as nitrocellulose membranes, using a device from V & P Scientific to make protein array product. Combination all three of array products herein make integrated bioarray system.

Analysis on integrated bioarray system is performed on DNA array product, RNA product and protein product respectively with different probe and different methods of detection. Analysis of DNA array product is conducted according to standard protocol with a probe labeled with fluorescein dUTP by asymmetric PCR. PCR template is a fragment of genomic DNA corresponding to 145941 to 146762 bp of the epidermal growth factor receptor (EGFR) gene (AF288738). The sequence of the single primer used in asymmetric PCR is: 5′TAMTGCCACCG GCAGGATGTG 3′. Probe for GAPDH gene is a fragment of 800 bp cDNA. Analysis of RNA array product is conducted by hybridization and detection of EGFR RNA transcripts according to standard procedure using a probe specific to exon 8 and 9 of EGFR mRNA. Probe for glyceraldehydes-3-phosphate dehydrogenase (GAPDH) gene is a fragment of 800 bp cDNA also. Probes are labeled with fluorescein dUTP by asymmetric PCR too.

Analysis of the protein array product is conducted according to standard procedures. Antibody against EGFR was from Santa Cruz Biotech and antibody against GAPDH was from Chemicon. After overnight incubations with recommended dilutions of the primary antibodies, the protein array products were washed with three changes of Tris Buffered Saline with Tween-20 (TTBS, Tris 20 mM, 0.9% Sodium Chloride, 0.1% Tween-20, pH 7.4) buffer. The protein array products were incubated with HRP (Horse Radish Peroxidase) conjugated antibodies for one hour. After three washes with TTBS, the protein array products are detected with ECL plus and signals are exposed to x-ray films.

Two fractions of genomic DNA recovered are found to contain EGFR hybridization signals on DNA array product as shown in FIG. 7. One of the fractions contains DNA molecules from 4.8 to 7.9 kb and the other fraction contains DNA molecules with smaller sizes, from 1.6 to 2.2 kb. While all tissue samples show hybridization signals at the similar fractions in the DNA array product, normal tissues have very weak signals and all tumor tissues show stronger EGFR gene hybridization signals, which indicate gene amplification in tumor tissues. The signals from these two fractions within any one of six tissue samples are proportional to each other. The lung tumor and the breast tumor have the highest copies of EGFR gene, which may be responsible for the increased amounts of EGFR proteins in these tumor tissues as explained later. Thus, analysis on DNA array product can quantitatively reveal the relative gene copies and the size of the DNA digests.

Five fractions of genomic DNA recovered are found to contain GAPDH hybridization signals on DNA array product as shown in FIG. 10. All six of tissue samples show hybridization signals at the similar fractions in the DNA array product, and signal intensities of GAPDH genes are relatively the same among the six tissue samples, which indicate that copies of GAPDH gene are the same among normal and tumor tissues. There is no signal detected in any the DNA fractions recovered from the cytoplasmic compartment, indicating that mitochondria DNA is not involved in EGFR gene.

There are three fractions contain EGFR mRNA transcripts out of 20 fractions on RNA array product displayed by hybridization with EGFR probe as shown in FIG. 6. Of them, the upper fraction (fifth fraction) that has the highest molecular weight contains transcripts between 10.91 to 8.63 kb, the middle fraction (eighth fraction) contains transcripts between 5.39 to 4.27 kb, and the lower fraction (tenth fraction) contains transcripts between 3.37 to 2.67 kb. The upper fraction with the highest molecular weight of EGFR transcript is believed to contain the 10.5 kb transcript that has reported earlier by other researchers. All normal, fetal and tumor tissues express this mRNA transcript of EGFR gene, but amounts of the mRNA transcripts are higher in tumor tissues and fetal tissue than that in normal tissues. The middle fraction (eighth fraction) contains EGFR mRNA transcripts between 5.39 to 4.27 kb. Three tumor tissues and one fetal tissue express this mRNA transcript but not the two normal adult tissues. The lower fraction (tenth fraction) is only expressed in the fetal liver and colon cancer in a relatively less amount.

The mRNA transcripts of EGFR gene with the highest molecular weight (10.5 kb) most likely encode the 170 kDa full length of EGFR protein shown in protein array product as shown in FIG. 5. The transcripts with the molecular weight in the middle may encode the middle-sized (130 kDa) EGFR protein while the transcripts with the lowest molecular weight may encode the EGFR protein in size of about 80 kDa. The expression levels of these transcripts in these tissues are well correlated with the respective expression levels of EGFR protein. Thus, the regulation of EGFR protein expression is constant at the level of translation from mRNA to protein. However, many different forms of EGFR transcripts as results of alternative splicing have been reported and the increasing complexity of this gene is still under vigorous investigation.

In the contrary, there is only one size of mRNA transcripts from GAPDH gene in all six of different tissues as shown in FIG. 9. The size of GAPDH mRNA is about 1.8 kb. Amounts of mRNA transcripts from GAPDH gene are related to types of tissues but not to the pathological statuses of tissues, such as there are more amounts of mRNA in both normal lung and tumor lung tissues than that in normal liver and fetal liver tissues, which indicates that GAPDH gene is specific in tissue types but not tumor specific. Both EGFR mRNA and GAPDH mRNA in nuclear compartments from all six different tissues show no visible hybridization signals indicating that pro-mRNA are not major population of mRNA for these two genes.

Corresponding to three major transcripts of mRNA, three fractions of protein out of 20 fractions are found to contain the EGFR proteins at different molecular weight on protein array product as shown in FIG. 5. The upper fraction with highest molecular weight contains EGFR proteins with 170 kDa (p170), the middle fraction contains proteins with 130 kDa (p130), and the EGFR protein in the lower fraction with smallest molecular weight corresponds 80 kDa (p80). It is rather apparent that the largest form of EGFR is the full length of EGFR protein commonly seen in many types of tissues and cells. It is over expressed in many tumor tissues and fetal tissue although it is also expressed in normal tissues at very low amount. This protein is located at membrane only in normal lung and liver tissues. In fetal and tumor tissues, this protein is also located at cytosol and nucleus besides membranes as shown in FIG. 5.

The EGFR protein with size of 130 kDa (p130) is most likely a cytosolic and nuclear protein in normal status since it only expressed in these two subcellular compartments of fetal tissue as shown in FIG. 5. However, once this EGFR protein with 130 kDa is distributed to the membrane, it may be related to tumor growth because it is only detected in lung tumor membrane. When located at membrane, this p130 could be similar somehow to that of EGFR VIII in which it may be in a constant activated status itself that in turn activates downstream signal transduction pathways, which are linked to active over-growth of tumor cells. This protein, however, may not be EGFRVIII variant because it is expressed in normal fetal liver and it is mostly distributed in the cytosolic and nuclear compartments whereas EGFRVIII should be overwhelmingly located in the membrane compartment. Therefore, this p130 EGFR protein could be a new protein related to tumor genesis under certain circumstances, as EGFR gene is a well-known oncogene and any variations of this gene could be potentially tumorgenesis.

There is an additional form of EGFR protein with lower molecular weight around 80 kDa as shown in FIG. 5. This protein is located at the nuclear compartment of fetal liver and the cytoplasmic compartment of colon tumors, but not in any subcellular compartments of normal tissues. Its function is very interesting and needs to be investigated further. So far, three forms of EGFR proteins are corresponded to the different forms of EGFR transcripts as results of alternative splicing have been reported. The expression levels of these proteins in these tissues are well correlated with the respective expression levels of EGFR mRNA transcripts. Thus, the regulation of EGFR protein expression is relatively constant at the level of translation from mRNA to protein. The increased amount of EGFR protein in tumor tissues or fetal tissue may be caused by over amplification of EGFR gene at DNA replication level in tumor tissues, or up-regulation of gene expression at transcription level from DNA to mRNA in fetal tissue.

As the same status of GAPDH mRNA, there is only one size of protein from GAPDH gene in all six of different tissues as shown in FIG. 8. The size of GAPDH protein is about 37 kDa. Amounts of GAPDH protein from GAPDH gene are related to types of tissues but not to the pathological statuses of tissues, such as there are more amounts of protein in both normal lung and tumor lung tissues than that in normal liver and fetal liver tissues, which indicates that GAPDH protein is specific in tissue types but not tumor specific. The GAPDH protein is located at cytosol compartment from all six different tissues.

Above applications on integrated bioarray system will produce a large amount of information or data. Generation and process of the information or data in this integrated bioarray system involves many steps described as follows. The parameters such as fluctuations in amount, size or molecular weight, fidelity, and location of DNA, RNA, protein, cDNA, tissue, and etc. are measured and judged by the standards of variations, mutations or polymorphisms in a high throughput manner.

Fluctuations in amounts of genetic materials can be measured in many different methods dependent on how the indicators or signals are collected. In this invention, scanning an exposed film carrying the indicators or signals of genetic materials with different intensities is performed for a densitometry analysis. Computerized data analysis will give out digital reading of amounts of genetic materials as shown in FIGS. 16, 17, and 18. Measurement of sizes is according to the numbers of nucleotides in DNA (bases pairs or bp) and RNA (bases), or the molecular weight of polypeptides in proteins (Dalton). Measurement of locations is very simple in this invention and it is based on which subcellular locations the indicators or signals are presented on bioarray products.

Measurements for amount, size and location are obvious and straight forwards, which are well recognized by scientific communities. But there is no such measurement for infidelity of genetic materials due to complexities of fidelity of genetic materials. The fidelity of genes is defined herein as the degree of authenticity for genetic materials, such as one or combinations of variations in sizes, structure or compositions of the same genetic materials. Examples for combined variations in sizes, structure, and compositions are restriction fragment length polymorphism (RFLP) in DNA, alternative splicing in mRNA, and alternative cleavages or modifications such as glycosylation or phosphorylation of protein in protein. Examples for variations in mere compositions are single nucleotide polymorphism (SNP) in DNA or RNA, single amino acid polymorphism (SAAP) in protein.

Scoring system presented here is just served as examples to illustrate the basic methods for measuring fidelity of genetic materials. Among measurements for fidelity as examples herein, score 1 is for highly authentic genetic materials, such that every tissues (six) have this genetic material (EGFR 170 kDa protein); scores 2 is for moderate authentic genetic materials, such that some tissues (four) have this genetic material (EGFR 130 kDa protein); and scores 3 is for less authentic genetic materials, such that a few tissues (two) have this genetic material (EGFR 80 kDa protein). The measurements for fidelity of RNA and DNA can be scores based on the same principles. These scores can be used as digital data for construction of database for gene functions. The other parameters can be scored also even though measurements for amount, size and location are obvious and straight forwards. The presentation statuses are defined and consist of the varieties or scores of the measurements of parameters. Characterization of the parameters according to the standards displays presentation status of DNA, RNA, protein, cDNA, tissue, and etc.

The presentation status of DNA, RNA, protein, cDNA, tissue, and etc. are displayed according to the standards and parameters with different attributes. Thus, a vertical and comprehensive analysis of these standards and parameters with different attributes is a key step to understand how DNA, RNA, protein, cDNA from a single gene works together correspondingly. The first vertical and comprehensive analysis of correlation and correspondence among the presentation status displays the expression profile. The second vertical and comprehensive analysis with comparison of relative changes of presentation status clarifies regulations in gene or protein expression. The third vertical and comprehensive analysis with integration of the sum changes of presentation status illustrates integrated expression effect of genetic materials, such as DNA, RNA, proteins, cDNA, tissues and etc. The functional patterns are developed by combination of the expression profiles, regulations in gene and protein expression, and integrated expression effect of genetic materials, such as DNA, RNA, proteins, cDNA, tissues and etc.

To measure the degree of regulation of gene expression, a scoring system with indicator of genetic materials can be applied. For examples, scales for measuring regulation of gene expression could be scored as 0 for normal status of regulation; scores 1 as up-regulation, scores 2 as over up-regulation; score −1 as down-regulation and scores −2 as over down-regulation. P stands for regulation at protein level; R for regulation at RNA level and D for regulation at DNA level.

To measure the degree of integrated expression effect of genes, a scoring system with indicator of genetic materials can be applied. Presentation statuses or variations in amounts of protein, RNA and DNA for EGFR can be scored as 1 if signal is at normal level, or as 2 if signal is stronger than normal level. Score is −1 if signal is below normal level. Scores for integrated expression effect are the sum of scores for effect of DNA, RNA, and protein. Thus, integrated expression effects of genetic materials (protein, RNA and DNA) for EGFR in tumor tissue is scores 6 (2 for protein, 2 for RNA and 2 for DNA) that are stronger than score 5 in fetal tissue (2 for protein, 2 for RNA and 1 for DNA). Both scores are much stronger than that in normal tissues (total score 3, 1 for protein, 1 for RNA and 1 for DNA). P, R and D stand for protein, RNA, and DNA.

A comprehensive analysis performed on the functional patterns of a gene (one set of genetic materials) annotates the conditioned functions of the gene in the piece of biomaterial under a particular condition. The conditioned functions of the gene illustrate the expression profiles of this gene, clarify how the expression of this gene is regulated, and define the integrated expression effect of this gene.

In this invention, conditioned functions of two genes (EGFR and GAPDH) horizontally across six different tissues under six different conditions as listed in FIG. 11 are presented as examples. The conditioned functions of the gene are the functions of this gene in a single piece of biomaterial under a particular condition. The conditioned functions of this gene may function very differently in different pieces of biomaterials under different conditions. As shown in FIG. 12, the conditioned functions of EGFR gene are very different among normal adult lung tissue, fetal liver tissue and lung tumor tissues. To fully understand comprehensive functions of EGFR gene, a horizontal and comprehensive analysis performed on the conditioned functions of this gene (one set of genetic materials) across different pieces of biomaterials accumulate the data for the comprehensive functions of this gene in the analyzed biomaterials. Repeating the horizontal and comprehensive analysis on the conditioned functions for every gene across different pieces of biomaterials under all different conditions will accumulate the data of the comprehensive functions for every gene.

Six conditioned functions of EGFR gene could be used to annotate the limited comprehensive functions of EGFR gene while six conditioned functions of GAPDH gene could be used to annotate the limited comprehensive functions of GAPDH gene. As shown in FIG. 12, three sets of conditioned functions of EGFR gene from three different tissues are quite different from each other. Comprehensive analysis of the three sets of conditioned functions of EGFR reveal that EGFR gene is playing a role in rapid growth of cells or tissue since EGFR gene is very active rapid growth of cells or tissue such as lung tumor and fetal tissue. All different tissues or a representative numbers of tissues need to be analyzed to get the completed comprehensive functions of EGFR and GAPDH genes. In the same principle, all genes need to be analyzed horizontally across all different tissues or a representative numbers of tissues to get the completed comprehensive functions of all genes.

The twelve conditioned function of genes listed above are stored in one data storage system. The data can be viewed from many different perspectives attributes as shown in FIG. 13. There are nine attributes in this database but it is organized as a database with three major attributes or dimensions. The three attributes served as dimensions are: 1) genetic materials distribution, such as DNA, RNA and protein; 2) biomaterials distribution, such as different tissues; and 3) genes distribution, such as DNA, RNA or protein from different genes. The other six attributes are embedded either inside datasheet or inside dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials as shown in FIG. 14 and FIG. 15. Three-dimensional databases with nine attributes are at highest hierarchy of databases. The hierarchical database is constructed from many two-dimensional databases by many different combinations of above nine attributes as shown in FIG. 13. Some combinations of three or more attributes from above nine attributes may lead to many different three-dimensional databases. This database only contains a limited six tissues and a limited two genes. Thus it is a limited three-dimensional database for limited comprehensive functions of genes.

This three-dimensional database can be used for annotating comprehensive functions of genes not only with large numbers of records, but also with limited numbers of records for annotating limited comprehensive functions of genes.

Accumulation from the data of the comprehensive functions for every gene forms a large three-dimensional database for the comprehensive functions of all genes in biomaterials. The genetic materials distribution, biomaterial distribution, and gene distribution determine the three dimensions for the three-dimensional database that contains the data for the comprehensive functions of all genes in biomaterials. The comprehensive functions of any gene or all genes can be annotated from the three-dimensional database by vertical, horizontal, comprehensive, and computerized analysis across different biomaterials under different conditions.

Comprehensive functions of genes can be annotated by analysis the three-dimensional database either by computerized database analysis or manually. How comprehensive the functions of a gene depend on how many sets of the conditioned functions of the gene are analyzed horizontally and comprehensively. As many sets of the conditioned functions of the gene as possible should be analyzed in order to annotate functions of a gene as comprehensive as possible or complete comprehensive. This will demand too much data to be processed manually for even only one gene, which is the time to use computerized database analysis. However, in most situations, there are not so many sets of the conditioned functions of the gene available for horizontal and comprehensive analysis. In addition, when horizontal and comprehensive analyses are performed on limited types of tissue under limited conditions as exampled in this invention by EGFR gene, the resulting functions of the gene are considered as limited comprehensive function of the gene, which still explored and identified many extra functions of this gene. Moreover, considering influence on functions of a gene by interactions between different genes, the comprehensive functions of related genes should be analyzed simultaneously also. Therefore, comprehensive function of a gene can be annotated by horizontal and comprehensive analysis of representative sets of conditioned functions of related genes in representative types of tissue under representative conditions.

Above description and examples have demonstrated that application of the high throughput and integrated bioarray system is the most effective technology to annotate the comprehensive functions of genes. The key strategy of this system is integration of DNA array product, RNA array product, protein array product, cDNA array product, tissue array product, and etc, although fragmentation and compartmentalization of genetic materials are as critical as the integration of array products also, especially in high throughput achievement. The integrated bioarray system is designed and intended to use as a set to get maximal information, but each individual array product or the combination of them can be used independently. Thus the Integrated bioarray system is highly flexible and highly modular in design.

As components of integrated bioarray system, every array product has its own application. DNA array product provides an important tool in understanding the correlation of genomic DNA aberration and phenotypic expression patterns. Genetic lesions such as amplification, point mutation, deletion, rearrangement, and acquisition of viral genes are usually found in tumor tissues. RNA array product can be used for evaluation of RNA transcripts from DNA. RNA determines the fate of protein, as RNA is the linkage between DNA and protein. RNA transcripts may be impaired such as over or under expression, truncation, point mutation, deletion, dislocation, and rearrangement in diseased conditions. These impairments impact protein functions directly or indirectly to cause abnormalities in organisms.

Application of protein array product reveals the consequence of variations in DNA and RNA. This is the most important array product in the integrated bioarray system. What protein does represents what gene (DNA and RNA) is for, but reverse may not be totally accurate. Regulation during translation of protein and modification of protein after its translation can affect protein expression and function dramatically. Researchers used to believe that expression of messenger RNA would represent the expression of protein. Now, researches have shown more and more data indicating the discrepancy between DNA, RNA and protein. This is why integrated bioarray system should be considered as the first choice.

cDNA array product possesses the similar application as RNA array product. For certain biomaterials with limited resources or certain genes with very lower transcript numbers, cDNA array product could be an alternative choice. The cDNA used in cDNA array could be first strand cDNA synthesized directly from either total RNA or mRNA, and the cDNA samples could also be double stranded cDNA. They may be amplified by our proprietary technology to increase the copy numbers for rare genes or for biomaterials with limited resources. Amplified cDNA can still possess the relative gene expression profile (the ratio of specific genes to house-keeping genes), thus it can be used to study low copy genes or to obtain enough amount of cDNA from biomaterials with limited resources because of the amplification process.

Tissue array product is, in some sense, the combination of DNA, RNA and protein array products since there are DNA, RNA and protein co-existed on the same section of tissue. Gene expression can be analyzed directly on the tissue array product at the DNA level by in situ PCR, at the mRNA level by in situ hybridization, or at the protein level by immunohistochemistry. There is an integrated system within tissue array product itself with some limitations. The major limitation of tissue array product is the very little amount of genetic materials carried by very thin tissue section, which cause lower sensitivities, false positive or negative results, and high background in detection of genetic materials. Unable to analyze the size or molecular weight of genetic materials is another limitation. The major advantage of tissue array product is the capability to locate exactly the positions of protein, RNA, or DNA in biomaterials.

Besides locating the position of genetic materials by tissue array product, other bioarray products in current invention also can position genetic materials. The specimens on DNA, RNA, or protein array products are compartmentalized as cytoplasmic, nuclear or membrane specimens. Genetic materials in different compartments of cells can be identified in integrated bioarray system. The size or molecular weight of genetic materials can also be distinguished in integrated bioarray system since the specimens on DNA, RNA, or protein array products are fractionated according to their size or molecular weight. Therefore, the integrated bioarray system can be considered as “virtual” tissue array with extra capabilities to distinguish size or molecular weight of genetic materials.

The high throughput and integrated bioarray system in this invention is fundamentally different from conventional cDNA mircoarray as shown in FIG. 22. Every spot of genetic materials on integrated bioarray system is the pooled products of genes from primary tissues or cell lines while that on conventional cDNA microarray is cDNA from a single gene. Probe used on integrated bioarray system is a single gene whereas that on on conventional cDNA microarray is a pooled product of genes from a single piece of tissues or a specific cell line. Application of integrated bioarray system identifies tissue profiling of a single gene, or finds one gene distributing among different tissues; application of conventional cDNA microarray identifies gene profiling in a single tissue, or finds different genes distributing in a tissue. Above all, the high throughput and integrated bioarray system in this invention can annotate the comprehensive functions of genes by analyses of expression profiles including amounts, sizes, fidelity and location of DNA, RNA and protein; analyses of regulation of gene expression; and analyses of integrated expression effects of genes, while conventional cDNA microarray can only analyze amounts of RNA at the isolated segment of machinery of gene functions. Therefore, the high throughput and integrated bioarray system in this invention is the most effective method to annotate comprehensive functions of genes in the existing technologies.

### EXAMPLE 1

### Making of Integrated Bioarray System

To make integrated bioarray system as shown in FIG. 4, one set of genetic materials such as DNA, RNA and protein is isolated from different compartments, such as cytosol, nucleus, and membrane compartments, in one piece of biomaterial. There are seven specimens from the isolation of one piece of biomaterial, cytoplasmic DNA, nuclear DNA, cytoplasmic RNA, nuclear RNA, cytoplasmic protein, nuclear protein, and membrane protein. The seven compartmentalized specimens of DNA, RNA and protein then are fractionated according to its size or molecular weight into 20 fractions respectively by gel electrophoresis. 140 compartmentalized and fractionated specimens of DNA, RNA and protein are recovered from gel fractions by different methods. Thus, each piece of biomaterial will lead to 140 compartmentalized and fractionated specimens of DNA, RNA and protein, 20 fractionated specimens of cytoplasmic DNA, 20 fractionated specimens of nuclear DNA, 20 fractionated specimens of cytoplasmic RNA, 20 fractionated specimens of nuclear RNA, 20 fractionated specimens of cytoplasmic protein, 20 fractionated specimens of nuclear protein, 20 fractionated specimens of membrane protein.

A selection of six sets of compartmentalized genetic materials is isolated from the selection of six pieces of biomaterials, i.e. normal lung tissue, lung tumor tissue, colon tumor, breast tumor, normal fetal liver, and adult normal liver. Every piece of biomaterials will produce 140 specimens. Thus, there are total 840 compartmentalized and fractionated specimens of DNA, RNA and protein from six pieces of biomaterials.

The 840 compartmentalized and fractionated specimens of DNA, RNA and protein are rearranged into three groups according to the characteristics of specimens, a group of DNA specimens, a group of RNA specimens, and a group of protein specimens. There are 240 specimens in DNA group, 240 specimens in RNA group, and 360 specimens in protein group. Specimens of 20 fractionated cytoplasmic DNA and 20 nuclear DNA from each of six tissues are in DNA group; specimens of 20 fractionated cytoplasmic RNA and 20 nuclear RNA from each of six tissues are in RNA group; and specimens of 20 fractionated cytoplasmic protein, 20 nuclear protein, and 20 membrane protein from each of six tissues are in protein group.

Each group of specimens is arrayed following an order from the first fractionated specimen to the 20^{th} fractionated specimen vertically, and horizontally from the cytoplasmic specimen of normal lung tissue, nuclear specimen of normal lung tissue, membrane specimen (protein only) of normal lung tissue; the cytoplasmic specimen of lung tumor tissue, nuclear specimen of lung tumor tissue, membrane specimen (protein only) of lung tumor tissue; the cytoplasmic specimen of colon tumor tissue, nuclear specimen of colon tumor tissue, membrane specimen (protein only) of colon tumor tissue; the cytoplasmic specimen of breast tumor tissue, nuclear specimen of breast tumor tissue, membrane specimen (protein only) of breast tumor tissue; the cytoplasmic specimen of fetal liver tissue, nuclear specimen of fetal liver tissue, membrane specimen (protein only) of fetal liver tissue; and the cytoplasmic specimen of adult normal liver tissue, nuclear specimen of adult normal liver tissue, membrane specimen (protein only) of adult normal liver tissue.

Three groups of specimens are arranged into three arrays, i.e. DNA array, RNA array and protein array. The order that the each array followed forms a designated order. The designated orders for each array are recorded and used for corresponding every specimen to each other on DNA array, RNA array and protein array, as well as to the six pieces of biomaterials, i.e. normal lung tissue, lung tumor tissue, colon tumor, breast tumor, normal fetal liver, and adult normal liver respectively. The specimens in DNA array, RNA array and protein array are immobilized onto a nylon membrane or a nitrocellulose membrane to make DNA array product, RNA array product and protein array product. Combination of all array products herein makes integrated bioarray system as shown in FIG. 4.

### EXAMPLE 2

### Parameters and Standard Applied in Bioarray System

After hybridizing or immunoblotting the bioarray membranes with gene specific probes or antibodies, blotting signals are captured either on exposed films or scanned in a computer. Four parameters listed in FIG. 3 are used to describe the fluctuations of activities in genetic materials revealed as hybridization or immunoblotting signals. The parameters named as amount, size, fidelity and locations herein can all be derived from each array product of the bioarray system. As illustrated in FIG. 5, the fluctuations of EGFR protein activities in the six tissues are measured. For example, the amount of 170 kDa EGFR protein is high in tumor lung, tumor colon, tumor breast and fetal liver and low in normal liver and normal lung tissues. The sizes of EGFR protein show three subunits with different molecular weights. Fetal liver contains all three subunits with molecular weights at 170, 130 and 80 kDa respectively. The fidelity of EGFR protein is varied in normal adult tissue, fetal tissue and tumor tissue since protein with different sizes are expressed differently among these tissues. The locations of EGFR protein are also clearly demonstrated in FIG. 5. EGFR can be located either in the membrane, cytosol, or nucleus compartments depended on the tissues.

The amounts of genetic materials can be measured in many different methods dependent on how the indicators or signals are collected. In this invention, scanning an exposed film carrying the indicators or signals of genetic materials with different intensities is performed for a densitometry analysis. Computerized data analysis will give out digital reading of amounts of genetic materials as shown in FIGS. 16, 17, and 18. Measurement of sizes is according to the numbers of nucleotides in DNA (bases pairs or bp) and RNA (bases), or the molecular weight of polypeptides in proteins (Dalton). Measurement of locations is very simple in this invention and based on which subcellular locations the indicators or signals are presented on bioarray products.

Measurements for amount, size and location are obvious and straightforward, which are well recognized by scientific communities. But there is no such measurement for infidelity of genetic materials due to complexities of fidelity of genetic materials. The fidelity of genes is defined herein as the degree of authenticity for genetic materials, such as one or combinations of variations in sizes, structure and compositions of the same genetic materials. Examples for combined variations in sizes, structure and compositions are restriction fragment length polymorphism (RFLP) in DNA, alternative splicing in mRNA, and alternative cleavages or modifications such as glycosylation or phosphorylation of protein in protein. Examples for variations in mere compositions are single nucleotide polymorphism (SNP) in DNA or RNA, single amino acid polymorphism (SAAP) in protein. Therefore, the measurement of the fidelity of genes is very complex and scoring system is proposed in this invention just served as example for the limited data in this invention as described later.

It has long been recognized that amounts of mRNA expressed are not necessary correlate with amounts of its corresponding proteins even though they should corresponding to each other generally, at least in housekeeping genes such as actin or GAPDH genes, according to central dogma. However, there are limited tools available for a systematic approach to measure the amounts of gene expressions in multiple levels from the same tissue source at the same time. Integrated BioArrays provide such a tool. Even more importantly, amounts of gene expression profile at the DNA, mRNA, and protein levels can be simultaneously measured in many samples at the same time in this invention, giving researchers a wealth of information on gene regulation patterns.

Compositions and structures of genes at the level of genomic DNA determine the length of genes, and eventually determine the molecular sizes of mRNA and protein. Since mutation, rearrangement, deletion, insertion all can lead to changes of the compositions and structures of the DNA, the corresponding length of gene products changes accordingly including molecular sizes of mRNA and protein. For examples, lesions at the DNA level identified in a collection of tumor population can be used to delineate phenotype subsets because lesions at the DNA level lead to corresponding changes in sizes of mRNA and protein by different mechanisms such as frame shifting. The other mechanism to generate mRNA and protein with different sizes by the same genes is alternative splicing of mRNA or alternative cleavages of protein both in normal or diseased conditions. These changes in sizes of DNA, RNA and protein are so complicated that many tumors behave as highly heterogenous disease and the underlying cause of this heterogenesity lies in the genetic variability.

Subcellular localization of proteins is tightly associated with their functions. Transcription factors can be cytosolic located in non-active state and can be mostly nuclear distribution upon activation. Protein arrays using BioChain's proprietary compartment proteins is an advantageous approach in directly localize the protein target in three major cell compartments: plasma membrane, cytosol, and the nucleus. For proteins that can be found at more than one cell compartment under normal or disease conditions, the percentage of each compartment distribution or ratios of a subset of proteins at the same compartment can be very important indications of cellular events.

All of the parameters listed in FIG. 3 can be measured with excellent success or even better than conventional methods. For examples, single nucleotide polymorphism (SNP) representing fidelity of genes can be measured much more accurate in this invention than in other conventional methods because compartmentalized and fractionated genomic DNA is applied either as solution or immobilized material in this invention to display the single nucleotide polymorphism. Application of compartmentalized and fractionated genetic materials will reduce the false positive information and enhance real positive information because the specific portions of genetic material are enriched. Background noises are decreased too because less amounts of non-specific genetic materials are introduced in assay systems when using compartmentalized and fractionated genetic materials.

The standards be used to judge the parameters are variations, mutations, and polymorphisms. For example, there are considerable variations of the amounts of the 170 kDa EGFR protein in the membrane compartments of normal tissues. Fetal liver membrane has much more EGFR than adult normal liver and lung tissues while adult normal lung has slightly more EGFR 170 kDa protein than adult normal liver. Mutations in the EGFR genomic DNA in tumor tissue are the sources of over-expressed mRNA and protein levels of EGFR in these tissues. Since the different sizes of EGFR mRNA and protein are possibly originated from the same source of DNA in fetal liver, for example, this shows polymorphism at mRNA level by alternative splicing and polymorphism at the protein level as a result of mRNA polymorphism.

### EXAMPLE 3

### Presentation Statuses of Genetic Materials

While the parameters describe the different aspects of the genetic material in biomaterials, they collectively display the expression status or presentation status of that genetic material in the particular biomaterials. So, the presentation status of a certain gene in a particular biomaterial is a condition that can be described by the parameters and is measured by the one or more bioarray assays. Presentation status is viewed at each or any levels of genetic materials with different characteristics. At least three classes of presentation statuses as DNA, RNA and protein can be presented by Bioarray system. The parameters for describing each class of presentation statuses are the same including amount, size, fidelity and locations although the biological meaning of the parameters is different for each class of presentation statuses. For example, FIG. 5 shows the EGFR protein in size of 170 kDa is presented in the membrane compartment in all the six tissues but at different amounts. The EGFR protein in size of 130 kDa can be found in different subcellular compartments of tumor and fetal tissues but not in adult normal lung and normal liver. The EGFR protein in size of 80 kDa is expressed lowest in amount among the three EGFR proteins and it can only be found in tumor colon cytosol and fetal liver nucleus. Variations in amount, size, fidelity and locations of EGFR protein as described above have cast the presentation status of EGFR protein in the limited variety of tissues under different conditions. The presentation statuses of the EGFR mRNA in different tissues are the amount, sizes, fidelity and locations of the EGFR mRNA in the particular tissue also. As shown in FIG. 6, EGFR mRNA has one, two or three forms or sizes of molecules with different weights in different tissues. They are all located at cytosol and the amount of the 10.5 kb transcript is much more in tumor tissues than that in normal lung or normal liver tissues. The three forms mRNA existed in tumor tissues could be mutation or considered as polymorphism or the results of alternative splicing since they exist in normal fetal tissue also. The presentation status of the EGFR DNA is featured by variations of amount, size and locations also. Tumor tissues and normal tissues do show the different presentation statuses. Taken together the presentation status of EGFR DNA in lung tumor, the presentation status of EGFR mRNA in lung tumor, and the presentation status of EGFR protein in lung tumor, we can vertically analyze the relationships between them and identify crucial information such as regulation points of the gene expression pathway. The presentation statuses are defined and consist of the varieties of the measurements of parameters. The measurements for other parameters except fidelity are self-descriptive. The measurements herein for fidelity are very difficult because of its complexities. Scoring system presented here is just served as examples to illustrate the basic methods for measuring fidelity of genetic materials. Among measurements for fidelity as examples herein, score 1 is for highly authentic genetic materials, such that every tissues (six) have this genetic material (EGFR 170 kDa protein); scores 2 is for moderate authentic genetic materials, such that some tissues (four) have this genetic material (EGFR 130 kDa protein); and scores 3 is for less authentic genetic materials, such that a few tissues (two) have this genetic material (EGFR 80 kDa protein). The measurements for fidelity of RNA and DNA can be scores based on the same principles. These scores can be used as digital data for construction of database for gene functions. The presentation statuses of genetic materials from different gene can be revealed with repetition of application different gene, such as GAPDH, on Bioarray system. FIGS. 8, 9, and 10 show the presentation statuses of protein, RNA and DNA from GAPDH gene.

### EXAMPLE 4

### Functional Patterns of Genetic Materials

The vertical relationships among presentation statuses of protein, RNA and DNA are analyzed vertically to identify correlation and correspondence of the presentations statuses. The expression profiles, regulations in expression, or integrated expression effect of genetic materials are the results of correlation and correspondence from vertical identification, vertical comparison, or vertical integration of the presentations statuses.

For example, in FIG. 5, EGFR protein is highly over-expressed in lung tumor on protein array product. Both the 170 kDa and 130 kDa EGFR proteins are found to be in the cytosol, nucleus, and membrane compartments as compared only low levels 170 kDa EGFR in the membrane compartment of the normal lung. In FIG. 6, results on RNA array product show that the cytosolic EGFR mRNA expressions in the tumor lung tissue are much higher than those from the normal lung tissue. Furthermore, there are also two populations of EGFR mRNAs in the cytosol of the lung tumor sample as compared to only the larger transcript in the normal lung. In FIG. 7, results on DNA array product reveal the genomic EGFR DNA distribution patterns. There are two fractions containing EGFR genomic DNA hybridization signals. This is because EcoRI cuts the targeted fragment in the DNA into two pieces of different sizes. The signal obtained from hybridization of genomic DNA from lung tumor is many times higher than that in normal lung tissue. From these vertical analyses, it is revealed that expression profiles of the genetic materials (protein, RNA, and DNA) for EGFR in the lung tumor and normal lung are quite different. The expression profiles of EGFR gene in lung tumor tissue could be defined as increasing in amount of DNA, RNA and protein of EGFR gene and expressing extra molecules with different size of RNA and protein of EGFR gene.

Based on the presentation statuses of EGFR protein, RNA, and DNA in lung tumor, regulation of EGFR gene expression in this tissue condition can be inferred by vertical comparing the presentation statuses. Over-expression of EGFR protein is thus a result of the increased expression of EGFR mRNA that in turn is determined by the number of copies of EGFR genomic DNA. In other words, gene amplification of EGFR at the genomic DNA level is the reason that mRNA levels of EGFR in the same lung tumor tissue are much higher than normal lung tissue. Increased EGFR mRNA is the cause of over-expression of EGFR at the protein level. The two different sizes of EGFR protein are also results of two EGFR mRNA transcripts respectively. However, the differences of EGFR mRNA sizes are not direct effect of EGFR DNA but likely results of alternative splicing. After comparison of the relative changes in the presentation status of the sizes of mRNA and protein and their relative amount and locations, we also can identify the critical regulation steps of the information flow. In the case of lung tumor, the critical step of gene regulation lies upstream of transcription.

To measure the degree of regulation of gene expression, a scoring system with indicator of genetic materials can be applied. For examples, scales for measuring regulation of gene expression could be scored as 0 for normal status of regulation; scores 1 as up-regulation, scores 2 as over up-regulation; score −1 as down-regulation and scores −2 as over down-regulation as shown in FIG. 12. P stands for regulation at protein level; R for regulation at RNA level and D for regulation at DNA level.

Variations in presentation statuses or amounts of protein, mRNA and DNA in the tissues are caused by regulation of gene expression while they lead to changes in integrated expression effect of genes. Integrated expression effect of genetic materials (protein, RNA and DNA) is a dynamic view on effect of protein, RNA and DNA by vertical integration in this invention although the definition of biological effect of EGFR gene expression is usually isolated at the protein level. Quantity and quality of protein determine the biological effect of protein while quantity and quality of protein are controlled by activities of DNA and mRNA, such as authenticity or fidelity of DNA; transcription efficiency from DNA to mRNA; correctness of translation protein from mRNA; post-translational modification of protein and etc. As shown in FIGS. 5 and 6, EGFR proteins and mRNA are highly expressed both in fetal tissue and in tumor tissues compared to normal tissues, but amounts of genomic DNA in fetal tissue and normal tissue are the same, both are less than that in tumor tissues as shown in FIG. 7.

To measure the degree of integrated expression effect of genes, a scoring system with indicator of genetic materials can be applied. Presentation statuses or variations in amounts of protein, RNA and DNA for EGFR can be scored as 1 if signal is at normal level, or as 2 if signal is stronger than normal level. Score is −1 if signal is below normal level. Scores for integrated expression effect are the sum of scores for effect of DNA, RNA, and protein. Thus, integrated expression effects of genetic materials (protein, RNA and DNA) for EGFR in tumor tissue is scores 6 (2 for protein, 2 for RNA and 2 for DNA) that are stronger than score 5 in fetal tissue (2 for protein, 2 for RNA and 1 for DNA). Both scores are much stronger than that in normal tissues (total score 3, 1 for protein, 1 for RNA and 1 for DNA) as shown in FIG. 12. P, R and D stand for protein, RNA, and DNA.

The scoring data could indicate a rationale that fetal tissue under rapid growth express EGFR mRNA and protein in high efficiency but it is under control as the amount of genomic DNA is not changed whereas tumor tissues under rapid growth over express EGFR mRNA and protein without control as amount of genomic DNA is increased too. Increasing amount of EGFR mRNA and protein in fetal tissue is a normal biological process and can come back to normal level when fetus becomes into adult since amount of genomic DNA is normal and increasing amount of EGFR mRNA and protein is caused by up-regulation of gene. The situation in tumor tissue is opposite to that in fetal tissues. Amount of DNA in tumor tissues is increased and increasing amount of EGFR mRNA and protein may not be caused by up-regulation of gene because even under a normal regulation of gene, increased amount of EGFR DNA in tumor tissues will cause increased amount of EGFR mRNA and protein. Therefore, increased amount of EGFR mRNA and protein is under control in fetal tissues, but is not under control in tumor tissues. The difference of score 5 and 6 of integrated expression effect between fetal tissues and tumor tissues reveals the life and death situations whereas evaluation only isolated at protein level cannot distinguish them.

Same biological effect by a protein may involve different interaction of DNA and mRNA upstream as described above. The biological effect by the protein may vary a lot when environment is changed as response of DNA and mRNA interaction could be different, which may lead to diseased condition, such as tumor. Therefore, the biological effect of protein should be the integrated expression effect of genetic materials including DNA, RNA and protein. It is a result subjected to many layers of expression status and regulation of genetic materials, and ultimately reflected at the amount, size, location and fidelity of the protein. Although protein bioarray alone can obtain the information on presentation status of protein, it should rely on the integration with other bioarrays to reveal the presentation status and regulatory process of DNA and RNA to understand how integrated expression effect genetic materials taking place.

The functional patterns of genetic materials are different from the presentation statuses of genetic materials in a few aspects. First, the presentation statuses are the display of isolated data of DNA, RNA and protein, in which their relationship and interaction are not revealed. The expression profiles as one component of the functional patterns of genetic materials include not only all the data of DNA, RNA and protein from the presentation statuses, but their relationship and interaction are vertically identified. Second and most important, two sets of the data, 1) regulation of gene and protein expression and 2) integrated expression effects as two other components of the functional patterns of genetic materials, are created by vertical comparison and vertical integration of the presentation statuses as shown in FIG. 12. These two components of the functional patterns of genetic materials are the most important functions of genes because they determine the fate of genes and eventually the fate of life, and there is no other existing ways to get these integrated data in an accurate and high throughput way.

### EXAMPLE 5

### Conditioned Function of Genes

Every single gene (such as EGFR) presents its own expression profiles, regulations in gene expression, or integrated expression effect of genetic materials in a specific tissue (such as lung tissue) under a specific condition (tumor or even more specific, adenocarcinoma, grade II). Combination of these specific expression profiles, regulations in gene expression, or integrated expression effect of EGFR genetic materials develop a specific functional pattern for EGFR gene. This specific functional pattern represents the functions of EGFR gene under the specific condition of the specific tissue. Thus it is defined as herein conditioned function of EGFR gene. There are six sets of conditioned function of EGFR gene corresponding to six different tissues with different conditions as shown in FIG. 11 to serve as examples in this invention. There are another six sets of conditioned function of GAPDH gene corresponding to six different tissues with different conditions as shown in FIG. 11 to serve as examples in this invention for better description of conditioned functions of different genes.

The functional pattern of each set of genetic materials in each biomaterial source presents a conditioned function that gene. Since six tissues are assayed for EGFR and GAPDH at levels of protein, RNA, and DNA expressions, we arrive at 12 conditioned functions for two genes. These twelve conditioned functions of genes of EGFR and GAPDH in six tissues as shown in FIG. 11 are listed in the following: 1) EGFR in Normal Lung; 2) EGFR in Tumor Lung; 3) EGFR in Tumor Colon; 4) EGFR in Tumor Colon; 5) EGFR in Fetal Liver; 6) EGFR in Normal Liver; 7) GAPDH in Normal Lung; 8) GAPDH in Tumor Lung; 9) GAPDH in Tumor Colon; 10) GAPDH in Tumor Breast; 11) GAPDH in Fetal Liver; and 12) GAPDH in Normal Liver.

Each set of conditioned functions of the gene contains a specific functional pattern or statement of the gene in the particular biomaterial. For examples, conditioned functions of EGFR gene in fetal tissue as shown in FIG. 12 thus states that EGFR DNA is located at nucleus with normal amount; three classes of EGFR mRNA transcripts are expressed in cytosol with elevated level compared with that in adult normal tissue and three classes of EGFR protein corresponding to mRNA are located in one, two or three subcellular compartments respectively with elevated amounts and different molecular sizes. Up-regulation of EGFR gene in fetal tissue is at the level of DNA transcribed into mRNA. The integrated expression effect of EGFR gene scores at 5, higher than that in adult normal lung tissue but lower than that in tumor tissue.

In the contrary, the conditioned functions of EGFR gene in tumor tissue as shown in FIG. 12 thus states that EGFR DNA is located at nucleus with much elevated levels; two transcripts of EGFR mRNA with different molecular sizes are expressed in cytosol with higher levels compared with adult normal tissue; two forms of the proteins with different molecular sizes corresponding to mRNA are located in all three major subcellular compartments and amounts of EGFR proteins are also elevated in tumor tissue. Up-regulation of EGFR gene in lung tumor tissue is at the level of DNA itself because of gene amplification. The integrated expression effect of EGFR gene scores at 6, higher than that both in fetal tissue and in adult normal tissue.

### EXAMPLE 6

### Three-dimensional Database for Comprehensive Functions of Genes

The twelve conditioned function of genes listed in FIG. 11 are stored in one data storage system to construct a database. The data can be viewed from many different perspectives or attributes as shown in FIG. 13. There are nine attributes in this database but it is organized as a database with three major attributes or dimensions. The three attributes served as dimensions are: 1) genetic materials distribution, such as DNA, RNA and protein; 2) biomaterials distribution, such as different tissues; and 3) genes distribution, such as DNA, RNA or protein from different genes. The other six attributes are embedded either inside datasheet or inside dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials.

Data of functional patterns from each set of conditioned functions of each gene are a record for databases. Every isolated data is an entry such as a defined size of a specific protein in a tissue under a condition. The databases at different hierarchies are constructed from many two-dimensional databases by many different combinations of above nine attributes as shown in FIG. 13. The hierarchies from high to low are databases for comprehensive functional patterns, for comprehensive parameters, and for individual parameters. Some combinations of three or more attributes from above nine attributes may lead to many different three-dimensional databases. The architectures of the three-dimensional databases in highest hierarchies containing all nine attributes are shown in FIGS. 14 and 15. This database only contains a limited six tissues and a limited two genes, thus it is a limited three-dimensional database with limited numbers of records for annotating limited comprehensive functions of genes.

Two-dimensional databases for expression profiles of protein, RNA, DNA, regulation of gene expression, integrated expression effects of genes can also contain more than two attributes as shown in FIGS. 16, 17, 18, 19 and 20 respectively. In these databases one dimension contains attributes of biomaterials distribution and subcellular location of genetic materials. The other dimension contains genes and size of genetic materials. The datasheet itself can embed some attributes also, such that the amount and fidelity embedded inside datasheets shown in FIGS. 16, 17, and 18, scores of regulations of gene expression embedded inside datasheet shown in FIG. 19, and scores of integrated expression effect of genetic materials embedded inside datasheet shown in FIG. 20. These two-dimensional databases are the components of three-dimensional databases. Combinations of these two-dimensional databases will generate different three-dimensional databases at different level of hierarchies. For examples, combination of FIGS. 16, 17, 18, 19 and 20 generates the database at highest hierarchy as shown in FIG. 15.

This three-dimensional database can be used for annotating comprehensive functions of genes not only with large numbers of records, but also with limited numbers of records for annotating limited comprehensive functions of genes.

A completed three-dimensional database served as the foundation for annotating the comprehensive functions of genes should include all genes in all different tissues under all different conditions. Each conditioned function of a gene can be considered as one record in the database. Within the three dimensions that serve as the basic search categories, data entries contain the variations of the parameters (amount, size, fidelity, and locations) and underlying standards (variations, mutation, polymorphism) of each gene. While the database should be designed to have defined record structure, defined data entry worksheet and searches on the database can be easily performed, it is beyond the scope of this invention to describe in details the implementation of the three-dimensional database.

### EXAMPLE 7

### Annotating Comprehensive Functions of Genes

Twelve functional patterns or conditioned functions of EGFR and GAPDH genes differ dramatically. When only one or two of them are presented, the view to the function of that gene is very narrow and may be even misleading. For example, EGFR protein is only presented in the membrane compartment in normal lung tissue and protein sequence information also suggests it is a membrane protein. It is widely believed that its function may only be the receptor of EGF as its name suggests. However, the presence of this protein in the nucleus implies that it may also act as a transcription factor. Indeed, a recent study confirms that it can bind to specific DNA domains and it is associated with the promoter region of cyclin D1 in vivo (Lin S-Y et al, Nature Cell Biology 3: 802, 2001). Another important issue is that even tissues diagnosed with the same type pathologically, i.e. non-small-cell carcinoma of the lung, they may differ very much in gene expression patterns. Only a percentage of the lung tumors actually carry EGFR gene amplification. Study of gene expression on a collection of lung tumors from different patients and at different tumor stages or conditions thus serve as tumor tissue profiling, and may lead to the identification of subsets of tumor-causing genes for each subset of lung tumors. Thus, comprehensive analysis of a gene requires the repetitive process of identifying many conditioned functions of a gene horizontally across many different biomaterials. This is exactly one of the crucial advantages of the bioarray system provides when many different types of biomaterials are arrayed on the same supported materials. As the collection of the biomaterials expands and reach a certain point that most of the biological conditions are represented, the function of gene can be considered as comprehensive.

Similarly, the expansion of different genes, such as EGFR, GAPDH, and etc., in the three-dimensional database is very crucial also to comprehensively analyze the comprehensive function of genes because genes interact each others inside cells like closed network. When a group of growth factor and growth factor receptor proteins are found to be over-expressed in lung tumor tissue, the roles of each individual growth factor or receptor or the combination of them may indicate the relative importance of them. Bioarray system in this invention provides an identical batch of bioarray products from the same set of genetic materials such as DNA, RNA, protein, and etc respectively in the same piece of biomaterials. The conditioned functions of different genes can be identified literally on the same set of genetic materials such as DNA, RNA, protein, and etc. respectively in the same piece of biomaterials. The clusters of functionally related genes that may co-express in the same biomaterial can be identified at multiple aspects of genetic materials such as DNA, RNA, protein, and etc. by this invention. The comprehensive functions of every gene related to each other can be annotated. Therefore, the closed network inside cells can be accurately mapped, which is the mission cannot be completed by conventional technologies, such as DNA microarray. In conventional DNA microarray method co-expression of a group of genes may not necessary state that these genes are of the same function or biologically related; they only point those possibilities because conventional DNA microarray method only analyzes an isolated aspect of genetic materials such as changes in amount of mRNA expression. Change in the amount of mRNA expression may be merely a tip of iceberg in the functions of most genes. As described above, DNA, RNA and protein are inter-determined each other dynamically. Besides change in the amount of mRNA expression, regulation and integrated expression effect of gene expression are the most crucial functions of genes, which, unfortunately, cannot be determined by conventional DNA microarray method.

Annotating comprehensive functions of genes becomes practical when a considerable size of the database is available. Based on the conditioned functions of EGFR and GAPDH genes analyzed on limited numbers of tissues described above, annotating the limited comprehensive functions of the EGFR and GAPDH genes is served as examples to illustrate what are the contents of the comprehensive functions of genes.

The first example is the limited comprehensive functions of EGFR genes (based on six different tissues under six different conditions) as shown in FIG. 12, which include three major activities of genetic materials: 1) gene expression profile including amount, size, fidelity and location of protein, RNA and DNA of EGFR gene in different tissues under different conditions; 2) regulation of EGFR gene expression in different tissues under different conditions; and 3) overall biological effect or integrated expression effect of EGFR protein, RNA and DNA in different tissues under different conditions.

EGFR protein is mainly a membrane protein in human adult tissues and functions as the receptor for EGF. It is highly expressed in the human fetal liver, providing evidence that it plays an important role either in tissues at early stage of development. Over-expression of EGFR is shown in multiple types of tumors including tumors of the lung, the colon, and the breast, in which tissues is at stage of rapid growth. Nuclear distributions of EGFR suggest the possible roles as transcription factor and other potential roles in the cytosol of developmental or rapid growth tissues. EGFR in these tumor conditions and in the fetal liver can have other subtypes of protein with different molecular weights. Comparing the subcelluar distribution of the 130 kDa EGFR, it is suggested that association of 130 kDa EGFR with the membrane is tumor specific and may contributes to tumor growth in the lung as shown in FIG. 5.

Three different sizes of EGFR proteins are outcomes of three different sizes of EGFR mRNA as shown in FIG. 6. The amounts of EGFR mRNA transcripts in different sizes are closely correlated with their protein counterparts. Alternative splicing is one of the mechanisms that lead to the different sizes of EGFR mRNA transcripts. At the genomic DNA level as shown in FIG. 7, amplification of EGFR gene is found in lung, colon, and breast tumors but not in fetal tissue. The amounts of gene amplifications at the genomic DNA level are tightly correlated to the increased amount of EGFR mRNA and protein in the tumors whereas increased amount of EGFR mRNA and protein in fetal tissue is not corresponding to the normal amount of EGFR gene at genomic DNA level.

Thus, in the three tumor tissues assayed, the increased copies of EGFR gene at genomic DNA level (score 1) are the major determinants of over expression of EGFR gene at mRNA and protein levels, while efficiency of DNA transcribed into RNA (score 0), and mRNA translated into protein (score 0), are at normal status, or regulations of gene transcription and translation are normal as shown in FIG. 12. Problem in tumor tissues is at genomic DNA level or DNA replication in tumor tissues is over regulated, which is a pathological condition. But in tissue at fetal stage, the increased amounts of EGFR gene at mRNA and protein level are the results of up-regulation of gene transcription from DNA into mRNA (score 1), since amount of EGFR gene at genomic DNA level is normal (score 0) and amount of protein is corresponding to the amount of mRNA (score 0) as shown in FIG. 12. These are physiological conditions since the increased amounts of EGFR gene at mRNA and protein level will come back to normal amount when up-regulation of gene transcription becomes normal regulation in tissue at adult stage.

Overall biological effects of EGFR gene including DNA, RNA and protein are strongest in tumor tissues with scores of integrated expression effect at 6. The scores are 5 in fetal tissue and 3 in adult normal tissue as shown in FIG. 12. Both tumor and fetal tissue present the same amount of EGFR protein, which indicate that EGFR gene may not be tumor related if the biological effects of EGFR protein alone are used as determinant factor. However, considering overall biological effects of EGFR DNA, RNA and protein or scores of integrated expression effect as determinant factor, EGFR gene becomes tumor related because EGFR gene is over and irreversible amplified at genomic DNA level. The overall biological effects of EGFR DNA, RNA and protein are much better indicators of gene functions than biological effects of EGFR protein alone. Unfortunately, the biological effects of EGFR protein alone are still the representative definition of gene function in the mind of almost all the people just because currently there is no such technology to provide all the integrated information about protein, RNA and DNA as this invention.

In summary of limited comprehensive functions of EGFR gene, EGFR protein is mainly a membrane protein in human adult tissues. It is highly expressed in the human fetal tissue and over-expressed in tumor tissues. Nuclear distributions of EGFR protein in fetal and tumor tissues suggest the possible roles as transcription factor and other potential roles in the cytosol of developmental or rapid growth tissues. It is suggested that association of 130 kDa EGFR with the membrane is tumor specific and may contribute to tumor growth in the lung. EGFR gene is over regulated at genomic DNA level or DNA replication in tumor tissues. EGFR gene is up-regulated at mRNA level or transcription of DNA into mRNA in fetal tissues. Tumor tissues present the strongest overall biological effects or integrated expression effect of EGFR gene, therefore, EGFR gene is tumor related because EGFR gene is over and irreversible amplified at genomic DNA level.

The second example is the limited comprehensive functions of GAPDH genes (based on six different tissues under six different conditions). As the limited comprehensive functions of EGFR, the comprehensive functions of GAPDH genes also include three major activities of genetic materials: 1) gene expression profile including amount, size, fidelity and location of protein, RNA and DNA of GAPDH gene in different tissues under different conditions; 2) regulation of GAPDH gene expression in different tissues under different conditions; and 3) overall biological effect or integrated expression effect of GAPDH protein, RNA and DNA in different tissues under different conditions.

GAPDH is a protein of single molecular weight at about 37 kDa. It is a cytosolic protein in all tissues. There are considerable variations in amount of GAPDH protein expressed among the six tissues. Tissue types rather than tissue development stages determine the amount of GAPDH protein since both adult liver and fetal liver have lower GAPDH protein than the rest of tissues. Study using RNA array reveals a similar pattern of GAPDH mRNA expression in the tissues as for its protein. GAPDH transcripts are at the same size. There are several different sizes of genomic fractions containing GAPDH hybridization signals indicating the existence of pseudogenes from different chromosome locations. Regulations of GAPDH gene expression in tumor tissue, fetal tissue and adult normal tissues are the same. Tissue specificity is regulated at mRNA level from genomic DNA transcribed into mRNA. Overall biological effect or integrated expression effect is related to tissue specificity. GAPDH gene is not tumor related and is a house-keeping gene.

Above two examples, although based on limited numbers of tissues, have shown that functions of the EGFR and GAPDH genes annotated by this invention are much comprehensive than any existed technologies. The comprehensive functions of the EGFR and GAPDH genes have revealed expression profiles, regulation in gene expression, and integrated expression effects of DNA, RNA and protein from these two genes in different tissues under different conditions. EGFR gene seems not directly relate to or interact with GAPDH gene each other.

### EXAMPLE 8

### Converting Information of Genetic Materials into Data to Annotating the Comprehensive Functions of Genes

The detection and collection of segregated and fractionated genetic information or data of DNA, RNA and protein from the same piece of biomaterials by a high throughput and integrated bioarray system in this invention is the most efficiency and accurate technology among other existing methods. Complicated pools of genetic information existed in cells of biomaterials are segregated into subcellular compartments and separated into fragments according to the locations and sizes of genetic materials that originate these information. The genetic materials possess these information are processed into the forms of compartmentalized and fractionated DNA, RNA and protein, then are applied on the integrated bioarray system as shown in FIG. 21. The segregated and separated pools of genetic information are detected by a variety of assays on the integrated bioarray system, and collected by different methods from the integrated bioarray system. The segregated and separated pools of genetic information are converted into isolated data in the format of parameters and standards. Logical organizations of these isolated data display the presentation statuses of DNA, RNA and protein from the same piece of biomaterials. At this point, genetic information or data of DNA, RNA and protein are isolated. The relationship or interaction of genetic information or data among DNA, RNA and protein are not revealed, which is, unfortunately, the current status of bioresearch in this field all over the world because there is no applicable, high throughput and integrated bioarray system to study the genetic information or data of DNA, RNA and protein as shown in FIG. 21 from the same piece of biomaterials.

Revealing relationship or interaction of genetic information or data among DNA, RNA and protein is made possible only by vertical analysis of the presentation statuses of DNA, RNA and protein. Vertical identification, vertical comparison, and vertical integration of presentation statuses of DNA, RNA, and protein reveal the relationship or interaction of genetic information or data among DNA, RNA and protein in the format of gene expression profiles, regulation of gene and protein expression, and integrated expression effects of genes. Combination of gene expression profiles, regulation of gene and protein expression, and integrated expression effects of genes develop the functional patterns of gene. The functional patterns of a gene define the conditioned functions of a gene in a tissue under a condition. The regulation of gene and protein expression, and integrated expression effects of genes are additional and valuable data created by vertical analysis of presentation statuses of DNA, RNA and protein. These are value added or extraordinary data over existing genetic information or data of DNA, RNA and protein created by this invention since no other existing technologies can provide these additional and valuable data regarding gene regulation and integrated effects of DNA, RNA and protein in the high throughput and integrated bioarray system.

To illustrate comprehensively the different functions of a gene in different tissues under different conditions, the high throughput and integrated bioarray system in this invention is the best way to perform the horizontal and comprehensive analysis of the functional patterns or conditioned functions of one gene across different tissues under different conditions. One set of functional patterns of one gene corresponds to one set of conditioned functions of one gene in one piece of tissue in one condition. The one set of conditioned functions of gene are functions of the gene in one piece of tissue in one condition. One gene will have many sets of the conditioned functions of the gene in many different tissues. There are many sets of genetic materials from many different tissues in many different conditions on the high throughput and integrated bioarray system. Many sets of functional patterns of one gene can be developed by horizontal and comprehensive analysis across many different tissues on the high throughput and integrated bioarray system. The more tissues are horizontal and comprehensive analyzed, the more sets of the conditioned functions of the gene can be obtained. The purpose of horizontal and comprehensive analysis of many sets of the conditioned functions of a gene is to annotate the comprehensive functions of a gene.

In addition, in order to consider influence on functions of a gene by interactions with other genes, the comprehensive functions of related genes should be analyzed simultaneously also. The outcome is that repetition of horizontal and comprehensive analysis of many different tissues (A) for all different genes (B) will generate a large number of sets (A×B=C) of the conditioned functions for all different genes. Therefore, in order to annotate accurately the comprehensive functions of genes, a computerized database analysis is necessary.

A three-dimensional database is constructed for these large number of sets (A×B=C) of the conditioned functions for all different genes. There are nine attributes in this database but it is organized as a database with three major attributes or dimensions. The three attributes served as dimensions are: 1) genetic materials distribution, such as DNA, RNA and protein; 2) biomaterials distribution, such as different tissues; and 3) genes distribution, such as DNA, RNA or protein from different genes. The other six attributes are embedded either inside datasheet or inside dimensions. 4) Amount embedded in the datasheet; 5) Size embedded in the datasheet and dimension of genes distribution; 6) Fidelity embedded in the datasheet; 7) Location embedded in dimension of biomaterials distribution; 8) Regulation of gene expression embedded in dimension of genetic materials; and 9) integrated expression effect of genes embedded in dimension of genetic materials. Data from each set of conditioned functions of each gene are defined as a record. Every isolated data is an entry such as a defined size of a specific protein in a tissue under a condition. The databases at different hierarchies are constructed from many two-dimensional databases by many different combinations of above nine attributes as shown in FIG. 13.

The hierarchies from high to low are in the order of databases for comprehensive functional patterns, for comprehensive parameters, and for individual parameters. Some combinations of three or more attributes from above nine attributes may lead to many different three-dimensional databases. The architectures of the three-dimensional databases in highest hierarchies are shown in FIGS. 14 and 15. This three-dimensional database can be used for annotating comprehensive functions of genes not only with large numbers of records, but also with limited numbers of records for annotating limited comprehensive functions of genes.

Comprehensive functions of genes can be annotated by analysis the three-dimensional database either by computerized database analysis or manually. How comprehensive the functions of a gene are depends on how many sets of the conditioned functions of the gene are analyzed horizontally and comprehensively. As many sets of the conditioned functions of the gene as possible should be analyzed in order to annotate functions of a gene as comprehensive as possible. This will demand too much data to be processed manually for even only one gene, thus it is best to use computerized database analysis. However, in most situations, there are not so many sets of the conditioned functions of the gene available for horizontal and comprehensive analysis, which made it not possible to have a completely comprehensive analysis. Fortunately, when horizontal and comprehensive analyses are performed on limited types of tissue under limited conditions as exampled in this invention by EGFR gene, the resulting functions of the gene are considered as limited comprehensive function of the gene, which still explored and identified many extra functions of this gene.

Moreover, considering influence on functions of a gene by interactions between different genes, the comprehensive functions of related genes can be analyzed simultaneously also by this invention. Therefore, comprehensive function of a gene can be annotated by horizontal and comprehensive analysis of representative sets of conditioned functions of a gene and related genes in representative types of tissue under representative conditions.

### EXAMPLE 9

### Applications in Annotating Dynamic Networking Interactions of Genetic Materials and Genes

Comprehensive functions of genes are a broad coverage of functions of genes. They include many aspects of functions of genes, such as gene expression profiles, regulations of genes expression, and integrated effects of genes expression. Isolated data of amount, size and location of genetic materials can be obtained by separated conventional methods in a low throughput manner as existing for many years in current scientific and research communities, but some functions of genes annotated by this high throughput and integrated bioarray system possess extraordinary features, such as annotating dynamic networking interactions of genetic materials and genes, including regulation of gene expression, integrated expression effects of genes, and interactions of different genes, which are very difficult or impossible sometimes for conventional method to obtain.

Dynamic networking interactions between the genetic materials of one gene or between genes, or regulation of genes expression, integrated expression effects of genes, and interaction of different genes are the most difficult features of functions of genes to annotate. Using the identical sources of biomaterials to identify regulation of genes expression, integrated expression effects of genes, and interaction of different genes in high throughput and integrated bioarrays system will add tremendous valuable information in identify such networking interactions of genes. For example, the amounts of both leptin mRNA and protein are increased by up to 20-fold in obese rodents with mutations of leptin or leptin receptor. The existence of a feedback mechanism controlling the amount of leptin in circulation is an example of networking interactions of related genes. Existing methods such as conventional DNA microarray experiments are frequently only able to find part or isolated networking or cluster of genes with unsure expression profile at only one level of genetic materials, such as mRNA level only. However, the interpretation of such co-expression has to be extremely careful because typically conventional DNA microarray experiments are performed using one type of cell or tissue under one physiological/pathological condition. When such correlation can be identified in multiple tissue sample arrays and can be further confirmed at DNA and protein levels by integrated bioarray system in this invention, the association of those two or more genes extrapolated by conventional DNA microarray experiments can be much more certain or conclusive.

It has long been recognized that amounts of mRNA expressed may not be necessary correlated with amounts of their corresponding proteins. The correlations are even more complicated than a simple answer of yes or no because some genes show the correlations between amounts of mRNA and protein in some tissues, and not in some other tissues. Generally speaking, they are correlated according to central dogma and they may not be correlated in some special situations, while these special situations are the most interests of focus, such as diseased situation. Thus, these are the correlations in dynamic changing at multiple directions. The dynamic changing can be concurrent or non-relevant. In addition, dynamic changing in amounts of DNA (such as in tumor tissues) may even complicate these correlations in dynamic changing of genetic materials such as DNA, RNA and protein. However, there are only limited tools existed or available for a systematic approach to measure correlations of genetic materials such as DNA, RNA and protein from the same tissue source at the same time, even on a single piece of biomaterials. Therefore, this invention provides high throughput and integrated Bioarrays system as a tool for annotating the correlations in dynamic changing of genetic materials such as DNA, RNA and protein from the same tissue source at the same time.

Variations in amounts of protein, mRNA and DNA in the tissues are caused by regulation of gene expression while they lead to changes in integrated expression effect of genes. Using the Integrated Bioarray system, it is expected that a researcher will obtain sufficient information to make a conclusion on the key regulatory steps, integrated expression effects of DNA, RNA and protein influenced by regulation of gene expression, and interaction of genes. At the same time, tissue distribution can be obtained also to conclude comprehensively. When a certain gene is suspected to be involved in a disease condition and no obvious indications of regulatory step between DNA, RNA and protein revealed by the Integrated Bioarray system, the results may point regulations beyond protein expression or interactions by other genes. In such cases, the function or activity of a protein may be related to post-translational modifications, protein stability, phosphorylation state, protein-protein interactions, protein-DNA, and protein-ligand interactions.

Even more importantly, not only the correlations in dynamic changing genetic materials such as DNA, mRNA, and protein can be simultaneously measured in many tissue samples at the same time, giving researchers a wealth of information on regulations of gene expression and integrated expression effects of genes, but also many related genes could be analyzed on the same integrated bioarray system literally to reveal networking interaction of genetic materials from different genes. The dynamic networking interactions of genes in multiple levels of genetic materials could be identified. Dynamic networking interactions between the genetic materials of one gene or between genes are therefore annotated.

### EXAMPLE 10

### Applications in Confirming Consequences due to Infidelity of Genes

Confirming consequences due to infidelity of genetic materials or genes are other extraordinary features possessed by this high throughput and integrated bioarray system, such as confirming the consequences of single nucleotide polymorphism (SNP) on DNA or on RNA, confirming originations of single amino acid polymorphisms (SAAP); confirming the consequences of restriction fragment length polymorphism (RFLP) on DNA or alternative splicing of RNA, or confirming originations of changes in compositions or sizes of proteins.

SNP is defined on DNA currently, but it can happen on RNA too as explained underneath. Traditionally, SNP is a substitute of single nucleotide base for another in genomic DNA or genes without obvious disturbance of gene phenotype. It is the most common type of DNA polymorphism (or infidelity of DNA as defined herein) among people. The frequency of SNP is each SNP for each 100 to 300 base pair of the human genome. At current more than 4 million SNP depositions are collected in the NIH SNP database. As mRNA is transcribed from DNA, SNP on RNA should inherit exactly from SNP on DNA. But this scenario needs to be proved further as transcription may not be so accurate, or may initiate new SNP that is not on DNA. Since the identification of SNP in individuals are the foundations for personalized medicine and the predict of disease predisposition, understanding of SNP distribution in tumors and other life threatening diseases is the key for the fulfillment of these two tasks.

Depends on the location of SNP in the gene, either on DNA or RNA, it can be categorized as intronic, 5′ UTR SNP, 3′UTR SNP, and exonic. Most of the exonic SNPs are silent. The rest of exonic SNPs cause either a conservative or a non-conservative amino acid change (single amino acid polymorphism, SAAP). The phenotypic SAAP can be caused by either SNP on DNA or SNP on RNA. Single nucleotide polymorphism can initiate at the mRNA level when transcription error happens, although SNP on DNA is most common origins. Furthermore, SAAP can originate at the level of protein translation, such as single amino acid substitution, insertion or deletion independent of SNP on DNA or SNP on RNA. Therefore, the SAAP can be initiated at three levels of genetic materials, SNP on DNA, SNP on RNA or protein translation per se. The latter two scenarios are very rare in a well-coordinated cellular environment but may be much more often in tumors when chaotic machinery is evolved. The integrated bioarray system in this invention is the extraordinary way to confirm whether or how SAAP is the consequence of SNP on DNA, SNP on RNA or others.

Other type of infidelity of genetic materials is the change in structure and compositions of genetic materials, such as restriction fragment length polymorphism (RFLP) in DNA, alternative splicing in RNA, alternative cleavage of protein, or modification or protein after translations such as glycosylation or phosphorylation. RFLP is the result from the insertion or deletion of a section or up to hundreds bases of DNA, which include microsatellite repeat sequences and gross genetic losses and rearrangement. Alternative splicing in RNA are multiple mRNA transcripts with different sizes form the same gene in genomic DNA. Alternative cleavages of protein occur on translated protein to generate proteins with different composition of amino acid and different sizes from the same gene or same mRNA transcripts. Glycosylation or phosphorylation can change the size of protein without change the composition of amino acid for the protein. The integrated bioarray system in this invention again is the extraordinary way for confirming where the change occurred and what consequences are incurred by these changes.

Three major features of this invention play the important roles to confirm consequences due to infidelity of genetic materials or genes: 1) Fractionating and compartmentalizing genetic materials; 2) Simultaneously analyzing DNA, RNA and protein on the same piece of biomaterials; and 3) High throughput confirmation across different tissues. For examples, single nucleotide polymorphism (SNP) or single amino acid polymorphisms (SAAP) representing infidelity of genes can be measured much more accurate with high sensitivities in this invention than in other conventional methods because compartmentalized and fractionated genomic DNA is applied either as solution or immobilized material in this invention to display the SNP or SAAP. Application of compartmentalized and fractionated genetic materials will reduce the false positive information and enhance real positive information because the specific portions of genetic material are enriched. Background noises are decreased too because less amounts of non-specific genetic materials are introduced in assay systems when using compartmentalized and fractionated genetic materials. This rationale is applied even beneficial in RNA and protein because sizes and locations are much more informative besides sensitivities and accuracy.

Thanks to the fact that DNA, RNA and protein from the same piece of biomaterials are analyzed simultaneously, the integrated bioarray system in this invention might be the only way to confirm whether SAAP is the consequences of SNP on DNA or SNP on RNA, and whether the protein with multiple sizes from the same gene are the consequences of RFLP in DNA, RNA alternative splicing, or alternative cleavage or modification of protein. Nowadays people predict or assume that consequence of SNP on DNA is corresponding SAAP on protein according to genetic code. These prediction and assumption may face serious challenges due to complexity of machinery involved in the central dogma. SAAP on protein in one tissue may not be the consequence of SNP on DNA in another tissue. Thus, for example, ideal process to confirm consequence of SNP on DNA should include confirming SNP on RNA and SAAP on protein from the same piece of biomaterials. It is even much necessary when confirming if the proteins with multiple sizes are the consequence of multiple copies of a gene on genomic DNA, or multiple transcripts of alternative spliced mRNA from one copy of this gene because there is no clue to predict according to, as in prediction of the consequence from SNP on DNA to SAAP on protein by genetic code.

Application of DNA array, RNA array and protein array products in integrated bioarray system, consequences of SNP on DNA can be confirmed either as SNP on RNA or SAAP on protein, or others. For detection of SNP in DNA and mRNA level, Duplex-Specific Nuclease Preference (DSNP) assay can be used. The method is a new, highly effective method of using the unique properties of the novel Duplex-Specific Nuclease (DSN) for detection of Single Nucleotide Polymorphisms (SNPs) and cSNPs (SNPs in mRNA transcription regions). Specific fluorescence-labeled probes complementary to wild-type and SNP type sequences are labeled with different dyes. The hybridization of hymozygous probe-target leads to the cleavage of blocking segments of the probe, leading to different color of fluorescence emission. The SNP on DNA or SNP on RNA can be detected. For detection of SAAP on protein, there are many methods can be used, such as specific antibody against the SAAP regions, or immunoprecipitation followed by sequencing.

Identification of a confirmed consequence of infidelity of a gene in one piece of biomaterials is only a tip of iceberg. It should be profiled on many representative biomaterials to determine its significance. For examples, an isolated SAAP on protein as the confirmed consequence of SNP on DNA or SNP on RNA may not have any clinical or applicable significance if it occurred in an extremely low prevalence or incidence among the population. High throughput confirmation across different tissues from different donors as the third major feature of this invention will determine how significant one type of infidelity of genes is in terms of accuracy, reproducibility and application for the sake of human being, such as finding a new clue and providing new strategies in diagnosis and treatments of diseases.

Therefore, fractionating and compartmentalizing genetic materials; simultaneously analyzing DNA, RNA and protein on the same piece of biomaterials; and high throughput confirmation across different tissues as three major features of this invention provide an extraordinary foundation to confirm consequences from infidelity of genetic materials or genes. There are no existing technologies comparable to this invention that can provide such integrated information or data about infidelity of genes at aspects of DNA, RNA and protein simultaneously.

The invention has been described using exemplary preferred embodiments. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A method in the analysis platform for annotating comprehensive functions of genes according to functional patterns (expression profiles, regulations in expression, or integrated expression effect) of DNA, RNA, proteins, cDNA, tissues and etc. from biomaterials on integrated bioarray system in a high throughput manner comprising the steps of
(1) Obtaining a set of specimens or genetic materials, such as DNA, RNA, proteins, cDNA, tissues and etc., from a single piece of biomaterial;
(2) From a selection of many pieces of biomaterials collecting the same selection of many sets of specimens or genetic materials, such as DNA, RNA, proteins, cDNA, tissues, and etc., respectively by repeating step (1). Any set of specimens or genetic materials from the selection of many sets of specimens or genetic materials herein is corresponding to a designated piece of biomaterial;
(3) Arranging specimens or genetic materials in step (2) according to their different characteristics, such as DNA, RNA, proteins, cDNA, tissues, and etc., into different groups of specimens or genetic materials, of which every specimen or genetic material in each group has the same characteristic, such as DNA, but come from different sets of specimens or genetic materials (from different pieces of biomaterials);
(4) Arraying every group of specimens or genetic materials in step (3) in a designated order to convert every group of specimens or genetic materials into arrays, such as DNA array, RNA array, protein array, cDNA array, tissue array, and etc;
(5) Recording the designated order for every arrayed specimen or genetic material on different arrays in step (4), such as DNA array, RNA array, protein array, cDNA array, tissue array, and etc. The designated order corresponds every arrayed specimen or genetic material to each other on different arrays, as well as to every designated biomaterial in the selection of many pieces of biomaterials in step (2) respectively; (6) Immobilizing or storing each and every array with the same characteristic, such as DNA, RNA, proteins, cDNA, tissues, and etc. respectively, in step (5) onto the same supporting or holding materials in the designated order to make array products respectively, such as DNA array product, RNA array product, proteins array product, cDNA array product, tissues array product, and etc. Combination of all array products herein makes integrated bioarray system; (7) Characterizing the expression profiles, regulations in expression, or integrated expression effect of specimens or genetic materials, such as DNA, RNA, proteins, cDNA, tissues, and etc., on integrated bioarray system in step (6) by different methods respectively, such as hybridization, immunoassay, vertical identification, vertical comparison, or vertical integration; (8) Developing the functional patterns by combination of characteristics, in step (7), of expression profiles, regulations in expression, or integrated expression effect of specimens or genetic materials, such as DNA, RNA, proteins, cDNA, tissues, and etc., on integrated bioarray system by comprehensive analysis; (9) Building up three-dimensional databases of the functional patterns, developed in step (8), by collecting the data from horizontal and comprehensive analysis of functional patterns across the selection of many pieces of biomaterials;
(10) Annotating comprehensive functions of genes by comprehensive analysis of functional patterns in three-dimensional databases of functional patterns in step (9) of DNA, RNA, proteins, cDNA, tissues, and etc. across the selection of many pieces of biomaterials on integrated bioarray system by computerized database analysis.

2. The method in claim 1, wherein the analysis platform is an integrated bioarray system in step (6) with instruments for automated or manual processes of specimens or genetic materials on integrated bioarray system for high throughput creating information or data for development of the functional patterns about function of genes in biomaterials, and computer hardware and software for high throughput collecting and processing information, and database analysis. The results of analysis from this platform annotate comprehensive functions of genes.

3. The method in claim 1, wherein the integrated bioarray system consists of array products with different characteristics of specimens or genetic materials, such as DNA array product, RNA array product, protein array product, cDNA array product, tissue array product, or etc. from different biomaterials. All array products in a specific integrated bioarray system contain specimens or genetic materials from the same selection of many pieces of biomaterials in step (2). The specimens or genetic materials on all array products in a specific integrated bioarray system are arrayed in the designated order. Within a specific integrated bioarray system the specimens or genetic materials, such as DNA, RNA, cDNA, protein, tissue, and etc., from a single piece of biomaterial are registered and corresponded to each other and to this single piece of biomaterial according to the designated order.

4. The method of claim 1, wherein the comprehensive functions of genes are the dynamic, complicated, interactive and integrated activities of the protein, RNA and DNA, such as expression profiles, regulations in expression, and integrated expression effect of protein, RNA, DNA and etc. from biomaterials.

5. In the claim 4, wherein the activities are the variations, mutations or polymorphisms in amount, size or molecular weight, fidelity of sequence, and locations.

6. In the claim 5, wherein the polymorphisms are variations in genes (DNA, RNA or cDNA) or proteins around normal status, such as variations in length or fidelity of genes or proteins.

7. In the claim 6, wherein the variations in length of genes or proteins include, but not limited, variations of fragments of genes (Restriction Fragment Length Polymorphism, RFLP in DNA or Alternative Splicing in RNA) and alternative cleavage of proteins or post translational modification of protein.

8. In the claim 6, wherein the variations in fidelity of genes or proteins include, but not limited, variation of a single nucleotide in genes (Single Nucleotide Polymorphism, SNP in DNA or RNA) or a single amino acid in proteins (Single Amino Acid Polymorphism, SAAP).

9. The method in claim 1, wherein the comprehensive function of genes are annotated by horizontal and comprehensive analysis of the functional patterns (expression profiles, regulations in expression, and integrated expression effect) of DNA, RNA, proteins, cDNA, tissues and etc. from biomaterials.

10. The method in claim 1, wherein the functional patterns are developed by combination of expression profiles, regulations in expression, and integrated expression effect of DNA, RNA, proteins cDNA, tissues and etc. from biomaterials.

11. The method in claim 1, wherein the expression profiles are the correlation and correspondence of the presentation status of DNA, RNA, proteins, cDNA, tissues and etc. vertically identified from biomaterials in aspects of variations, mutations or polymorphisms in amount, size or molecular weight, fidelity of sequence, and locations.

12. The method in claim 1, wherein the regulations in expression are reasoned and clarified by vertical comparison among relative changes of presentation status of DNA, RNA, proteins, cDNA, tissues and etc. from biomaterials in aspects of variations, mutations or polymorphisms in amount, size or molecular weight, fidelity of sequence, and locations.

13. The method in claim 1, wherein the integrated expression effect is the result of vertical integration on sum changes of presentation status of DNA, RNA, proteins, cDNA, tissues and etc. from biomaterials in aspects of variations, mutations or polymorphisms in amount, size or molecular weight, fidelity of sequence, and locations.

14. The method in claim 1, wherein the high throughput manner is achieved by application of specimens or genetic materials from biomaterials on integrated bioarray system at high density, automated process and computerized data collection and analysis.

15. The method in claim 1, wherein the biomaterials are the materials from any organisms, such as human tissues, animal tissues, plant tissues, cultured cells or tissues, and etc.

16. The method in claim 1, wherein the specimens or genetic materials in step (1) can be the compartmentalized specimens separated from different cell compartments, such as cytosol, nucleus, membrane, and etc.

17. The method in claim 1, wherein the specimens or genetic materials in step (1) can be fractionated according to their molecular properties, such as size or weight, charges, solubility, density, affinity, mass or color, and etc. The fractionated specimens or genetic materials herein can be recovered by different methods.

18. The method in claim 1, wherein every set of specimens or genetic materials in one selection of many set of specimens or genetic materials in step (2) are corresponding (as each individual set of specimens or genetic materials respectively) to every piece of biomaterials in the same selection of many pieces of biomaterials.

19. The method in claim 1, wherein the specimens or genetic materials in every group of the different groups of specimens or genetic materials in step (3) are come from the same selection of many pieces of biomaterials in step (2).

20. The method in claim 1, wherein the designated order in step (4) determines the positions of the every specimen or genetic material (such as DNA, RNA, proteins, cDNA, tissues, and etc.) on different groups of specimens or genetic materials (such as DNA group, RNA group, protein group, cDNA group, tissue group, and etc.) respectively.

21. The method in claim 1, wherein the method of correspond in step (5) is to register a single piece of biomaterial to every specimen or genetic material in a set of specimens or genetic materials, such as DNA, RNA, proteins, cDNA, tissues and etc. obtained from the single piece of biomaterial herein in step (1). The specimens or genetic materials of DNA, RNA, cDNA, proteins, tissues and etc. within the same set herein are registered to each other also.

22. The method in claim 1, wherein the arrays in step (6) can be immobilized onto supporting or holding materials or not. The supporting or holding materials herein for array products can be any materials that can support or hold specimens or genetic materials, such as membrane, tubes, multiple well plate, beads, plastic, glass, and etc. Further these supporting or holding materials can be treated to have a charge or chemically modified to carry molecules binding enhancers such as poly-lysine or the slide can be silylated and silanated.

23. The method in claim 1, wherein the methods of immobilizing the arrayed specimens or genetic materials to the supporting materials in step (6) can be automated by using devices such as micro-arrayers or by manually with or without any devices.

24. The method in claim 1, wherein the methods for characterizing the expression profiles, regulations in expression, and integrated expression effect of immobilized specimens or genetic materials in step (7) can be automated or manual with or without high throughput manner.

25. The method in claim 1, wherein the vertical methods in step (7) is to characterize a set of specimens or genetic materials, such as DNA, RNA, protein, cDNA, tissue, and etc. from the same piece of biomaterials correspondingly to each other.

26. The method in claim 1, wherein the functional patterns can be developed in step (8) without computerized database analysis.

27. The method in claim 1, wherein the three dimensions for databases in step (9) are the dimension of genetic materials or gene(s) products with different characteristics (DNA, RNA, protein, and etc.); the dimension of the same gene(s) distribution profile on biomaterials under different condition; and the dimension of the different genes (products) with the same characteristics (DNA, RNA, protein, and etc.) distribution profile on the same biomaterial.

28. The claim 27, wherein the gene(s) can be the same piece(s) or fragment(s) of specimens or genetic materials, such as fragment(s) of genomic DNA for actin gene, piece(s) of actin mRNA, piece(s) of actin protein, and etc.

29. The method in claim 1, wherein the three-dimensional databases in step (9) have at least nine attributes including, but not limited, 1) Genetic materials such as DNA, RNA protein; 2) Biomaterials; 3) Genes; 4) amount that is embedded in the datasheet; 5) size that is embedded in the datasheet and in the dimension of genes; and 6) fidelity that is embedded in the datasheet; 7) location of subcellular compartments that is embedded in dimension of biomaterials; 8) regulation of gene expression that is embedded in dimension of genetic materials; and 9) integrated expression effect of genes that is embedded in dimension of genetic materials.

30. The method in claim 1, wherein the three-dimensional databases in step (9) are constructed from many two-dimensional databases by many different combinations of above nine attributes. Some combinations of three or more attributes from above nine attributes may lead to many different three-dimensional databases.

31. The method in claim 1, wherein the functional patterns of each gene are used as a record for three-dimensional databases in step (9). Every individual data, such as a defined size of a specific protein in a tissue under a condition is used as an entry for three-dimensional databases in step (9).

32. The method in claim 1, wherein the horizontal method in step (9) analyzes the functional patterns across many different pieces of biomaterials.

33. The method in claim 1, wherein the comprehensive functions of genes in step (10) can be annotated without computerized database analysis.
